(19) United States
(12) Patent Application Publication
(10) Pub. No.: US 2014/0178756 A1
(43) Pub. Date: Jun. 26, 2014

(54) COMPOSITE PARTICLES FOR ELECTROCHEMICAL DEVICE ELECTRODE, MATERIAL FOR ELECTROCHEMICAL DEVICE ELECTRODE, ELECTROCHEMICAL DEVICE ELECTRODE, AND ELECTROCHEMICAL DEVICE

(71) Applicants: Takuya Ishii, Tokyo (JP); Yuuki Ohkubo, Tokyo (JP)

(72) Inventors: Takuya Ishii, Tokyo (JP); Yuuki Ohkubo, Tokyo (JP)

(73) Assignee: ZEON CORPORATION, Tokyo (JP)

(21) Appl. No.: 14/237,097

(22) PCT Filed: Aug. 2, 2012
(86) PCT No.: PCT/JP2012/069701

§ 371 Date: Feb. 4, 2014

(30) Foreign Application Priority Data
Aug. 4, 2011 (JP) 2011-170729
Aug. 10, 2011 (JP) 2011-174480

(51) Int. Cl. H01M 4/62

(52) U.S. Cl. CPC H01M 4/622
USPC 429/211; 252/182.1

(57) ABSTRACT

Composite particles for electrochemical device electrode containing an electrode active material and a particle-shaped binder, wherein said binder includes a copolymer which contains a nitrile group-containing monomer unit, a monomer unit which has an acidic functional group, and a monomer unit which contains a C₄ or more linear alkylene structure, in which a ratio of content of said nitrile group-containing monomer unit is 10 to 50 wt % and the iodine value is 3 to 40 mg/100 mg are provided.

### TECHNICAL FIELD

The present invention relates to composite particles for electrochemical device electrode, a material for electrochemical device electrode, an electrochemical device electrode, and an electrochemical device.

### BACKGROUND ART

Small-sized, light weight, high energy density and repeatedly chargeable and dischargeable lithium ion secondary cells and other electrochemical devices are rapidly growing in demand due to their properties. Lithium ion secondary cells are relatively large in energy density, so are being utilized in mobile phones, notebook personal computers, electric vehicles, and other fields.

These electrochemical devices are being required to be made lower in resistance, higher in capacity, better in mechanical properties and productivity, and otherwise improved more along with the expansion and growth in applications. In view of this situation, higher productivity methods of production are being sought for electrochemical device electrodes as well. Various improvements are being made to methods of production enabling high speed shaping and materials for electrochemical device electrode which are suitable with the methods of production.

Electrochemical device electrodes are usually formed by laminating an electrode active material layer formed by bonding an electrode active material and a conductive material which is used in accordance with need which by a binder on a current collector. As a method for forming such an electrode active material layer, Patent Document 1 discloses the method of obtaining an aqueous slurry which contains an electrode active material, rubber particles, and a dispersant constituted by water, spray drying the obtained aqueous slurry to obtain a particle-shaped electrode material, and using the obtained electrode material to form an electrode active material layer.

However, in the art described in the above Patent Document 1, the flexibility of the obtained electrode and the adhesion of the current collector and electrode active material layer are not sufficient. For this reason, the internal resistance and high temperature cycle characteristics and other cell characteristics were inferior.

Further, when using the coating method to form an electrode active material layer like in the past, at the time of drying the solvent after coating, there was the problem that the binder ended up segregating at the surface of the electrode active material layer and the internal resistance ended up becoming higher.

In addition, among electrochemical device electrodes, electrodes which are used at the positive electrode side are high in oxidation reduction potential during charging and discharging. For this reason, the binder which is contained in the positive electrode is also exposed to a high oxidizing environment. In such a binder as well, excellent oxidation resistance is sought. In particular, in recent years, for raising the capacity of electrochemical devices, as active materials for positive electrode, attention is focusing on an active material for positive electrode which contains nickel or other transition metals. When using such an active material, the binder is exposed to a much harsher oxidizing environment compared with the past, so from this viewpoint as well, a binder which is excellent in oxidation resistance is being sought. Further, when using an active material which contains nickel or other transition metals as the active material for positive electrode, if using the coating method to form the positive electrode active material layer like in the past, there is also the inconvenience of the aluminum current collector ending up corroding and the shapeability and cell characteristics ending up falling.

### PRIOR ART DOCUMENTS

### Patent Documents

Patent Document 1: Japanese Patent No. 4219705

### SUMMARY OF THE INVENTION

### Problem to be Solved by the Invention

The present invention has as its object the provision of composite particles for electrochemical device electrode which are high in adhesion to the current collector, excellent in shapeability, and can give an electrochemical device electrode which is low in internal resistance and excellent in high temperature cycle characteristics. Further, the present invention has as its object the provision of a material for electrochemical device electrode, electrochemical device electrode, and electrochemical device which are obtained by using such composite particles for electrochemical device electrode.

### Means for Solving the Problems

The inventors engaged in in-depth research so as to achieve the above object and as a result discovered that composite particles which contain an electrode active material and predetermined particle-shaped binder are high in adhesion to a current collector, excellent in shapeability, and, when made into an electrode, can give a low internal resistance and an excellent high temperature cycle characteristics and thereby completed the present invention.

That is, according to the present invention, there are provided composite particles for electrochemical device electrode containing an electrode active material and a particle-shaped binder, wherein the binder includes a copolymer which contains a nitrile group-containing monomer unit, a monomer unit which has an acidic functional group, and a monomer unit which contains a C₄ or more linear alkylene structure, in which a ratio of content of said nitrile group-containing monomer unit is 10 to 50 wt % and the iodine value is 3 to 40 mg/100 mg.

In the composite particles for electrochemical device electrode of the present invention, preferably the acidic functional group is at least one group which is selected from a carboxylic acid group, sulfonic acid group, and phosphoric acid group.

In the composite particles for electrochemical device electrode of the present invention, preferably the binder includes an acrylic polymer which contains a (meth)acrylic acid ester monomer unit as a main ingredient, and an iodine value of the binder as a whole is 3 to 30 mg/100 mg.

In the composite particles for electrochemical device electrode of the present invention, the particles further contain an antioxidant in 0.05 to 3 parts by weight with respect to 100 parts by weight of the binder.

In the composite particles for electrochemical device electrode of the present invention, preferably the antioxidant is an amine-based antioxidant and/or phenol-based antioxidant.

According to the present invention, there is provided a material for electrochemical device electrode which contains any of the above the composite particles for electrochemical device electrode.

Further, according to the present invention, there is provided an electrochemical device electrode comprising an active material layer which is formed by using the above material for electrochemical device electrode laminated on a current collector.

The electrochemical device electrode of the present invention is preferably one in which the electrode active material layer is laminated on the current collector by press forming, more preferably is one laminated on the current collector by roll press forming.

Furthermore, according to the present invention, there is provided a method of production of any of the above composite particles for electrochemical device electrode comprising a step of making the electrode active material and the binder disperse in water to obtain a slurry and a step of spraying and drying the slurry to form granules.

Alternatively, according to the present invention, there is provided a method of production of any of the above composite particles for electrochemical device electrode comprising a step of making the electrode active material, the binder, and the antioxidant disperse in water to obtain a slurry and a step of spraying and drying the slurry to form granules.

### Effects of the Invention

According to the present invention, it is possible to provide composite particles for electrochemical device electrode which are high in adhesion to a current collector, excellent in shapeability, and can give an electrochemical device electrode which is low in internal resistance and excellent in high temperature cycle characteristics and a material for electrochemical device electrode, electrochemical device electrode, and electrochemical device which are obtained by using such composite particles for electrochemical device electrode.

### DESCRIPTION OF EMBODIMENTS

The composite particles for electrochemical device electrode of the present invention contains an electrode active material and a particle-shaped binder, and the binder includes a copolymer which contains a nitrile group-containing monomer unit, a monomer unit which has an acidic functional group, and a monomer unit which contains a C₄ or more linear alkylene structure, wherein a ratio of content of the nitrile group-containing monomer unit is 10 to 50 wt % and the iodine value is 3 to 40 mg/100 mg.

(Electrode Active Material)

The electrode active material used in the present invention is suitably selected in accordance with the type of the electrochemical device. For example, as the electrode active material for positive electrode of a lithium ion secondary cell, a compound which contains a transition metal, specifically, an oxide which contains a transition metal or a composite oxide of lithium and a transition metal may be used. As examples of such a transition metal, cobalt, manganese, nickel, iron, etc. may be mentioned, but in the present invention, a compound which contains nickel, in particular, a composite oxide which contains lithium and nickel, is suitably used. In particular, a composite oxide which contains lithium and nickel has a high capacity compared with the lithium cobalt oxide (LiCoO₂) which has been used as a positive electrode active material in lithium-based secondary cells in the past, so is suitable. As the composite oxide which contains lithium and nickel, for example, one of the following general formula may be mentioned.

LiNi_{1-x-y}CoₓMO₂

(where, 0≦x<1, 0≦y≦1, x+y<1, and M is at least one element selected from B, Mn, and Al)

Further, as the electrode active material for negative electrode of a lithium ion secondary cell, for example, amorphous carbon, graphite, natural graphite, mesocarbon microbeads (MCMB), and pitch-based carbon fiber and other carbonaceous materials; polyacene or other conductive polymers; Si, Sn, Sb, Al, Zn, and W which are able to alloy with lithium, etc. may be mentioned.

Alternatively, as an electrode active material for electric double-layer capacitor, usually an allotrope of carbon may be used. The electrode active material for electric double-layer capacitor is preferably one of a large specific surface area which can form an interface of a broader area even with the same mass. Specifically, the specific surface area is 30 m²/g or more, preferably 500 to 5,000 m²/g, more preferably 1,000 to 3,000 m²/g in range. As specific examples of the allotrope of carbon, activated carbon, polyacene, carbon whiskers, graphite, etc. may be mentioned. These powders or fibers can be used. Among these as well, activated carbon is preferable. Specifically, a phenol-based, rayon-based, acryl-based, pitch-based, or coconut husk-based, or other activated carbon may be mentioned.

Furthermore, as the electrode active material for lithium ion capacitor, the above-mentioned electrode active material for electrical double-layer capacitor may be used as the active material for positive electrode and, further, the electrode active material for negative electrode of above-mentioned lithium ion secondary cell may be used as the active material for negative electrode.

(Particle-Shaped Binder)

The particle-shaped binder used in the present invention contains a copolymer which has a particle shape and which contains a nitrile group-containing monomer unit, a monomer unit which has an acidic functional group, and a monomer unit which contains a C₄ or more linear alkylene structure, the ratio of content of the nitrile group-containing monomer unit being 10 to 50 wt % and the iodine value being 3 to 40 mg/100 mg (below, sometimes referred to as a “nitrile polymer”).

The particle-shaped binder used in the present invention may be any which has a particle shape, one which can be present in the composite particles for electrochemical device electrode of the present invention in a state holding the particle state, that is, in a state holding the particle state on the electrode active material, is preferable. By being present in the composite particles for electrochemical device electrode in a state holding the particle shape, it becomes possible to bond the particles of the electrode active material well without impairing the electron conduction. That is, it is possible to obtain good bonding of electrode active material particles with each other without increasing the internal resistance. Note that, in the present invention, “state holding the particle shape” does not have to be a state holding the particle shape completely. It is sufficient that it be a state holding the particle shape to a certain extent. For example, as a result that it makes the particles of the electrode active material bonded together, it may be a shape which is pressed in a certain extent by force being given by these electrode active material.

As the nitrile group-containing monomer which forms the nitrile group-containing monomer unit which forms part of the nitrile polymer which is contained in the particle-shaped binder used in the present invention, for example, acrylonitrile; α-chloroacrylonitrile, α-bromoacrylonitrile, and other α-halogenoacrylonitriles; methacrylonitrile, and other α-alkylacrylonitriles; etc. may be mentioned. Among these as well, acrylonitrile and methacrylonitrile are preferable, and acrylonitrile is more preferable. The nitrile group-containing monomer may be used as single type alone or as a plurality of types combined.

The ratio of content of the nitrile group-containing monomer unit in the nitrile polymer which is contained in the particle-shaped binder used in the present invention is 10 to 50 wt % with respect to the total monomer units, preferably 20 to 40 wt %, more preferably 30 to 40 wt %. If the ratio of content of the nitrile group-containing monomer unit is too small, the dispersability of the electrode active material at the time of preparing the slurry falls and the shapeability becomes inferior. Due to this, the high temperature cycle characteristics when made into an electrode ends up falling. On the other hand, if too great, the swellability with respect to the electrolytic solution of the nitrile polymer which is contained in the particle-shaped binder ends up becoming high. Due to this, the high temperature cycle characteristics when made into an electrode ends up falling.

Further, the monomer which has an acidic functional group forming the monomer unit which has an acidic functional group forming the nitrile polymer which is contained in the particle-shaped binder used in the present invention is not particularly limited so long as a monomer which has an acidic functional group, but in the present invention, at least one selected from a monomer which has a carboxylic acid group as an acidic functional group, a monomer which has a sulfonic acid group, and a monomer which has a phosphoric acid group is preferable, at least one selected from a monomer which has a carboxylic acid group and a monomer which has a sulfonic acid group is more preferable, and a monomer which has a carboxylic acid group is furthermore preferable. Note that, by containing a monomer unit which has an acidic functional group, it is possible to make the adhesion to the current collector and the bonding force of the binder excellent.

As specific examples of the monomer which has a carboxylic acid group, acrylic acid, methacrylic acid, crotonic acid, and other monocarboxylic acids; 2-ethylacrylic acid, isocrotonic acid, α-acetoxyacrylic acid, β-trans-aryloxyacrylic acid, α-chloro-β-E-methoxyacrylic acid, β-diaminoacrylic acid, and other derivatives of monocarboxylic acids; maleic acid, fumaric acid, itaconic acid, and other dicarboxylic acids; maleic acid anhydride, acrylic acid anhydride, methylmaleic acid anhydride, dimethylmaleic acid anhydride, and other anhydrides of dicarboxylic acids; methylmaleic acid, dimethylmaleic acid, phenylmaleic acid, chloromaleic acid, dichloromaleic acid, fluoromaleic acid, diphenyl maleate, nonyl maleate, decyl maleate, dodecyl maleate, octadecyl maleate, fluoroalkyl maleate, or other derivatives of dicarboxylic acids; etc. may be mentioned. These may be used alone or in combinations of two or more types. Among these as well, methacrylic acid and maleic acid are preferable, and methacrylic acid is more preferable.

As specific examples of a monomer which has a sulfonic acid group, as a sulfonic acid group-containing monomer, vinylsulfonic acid, styrenesulfonic acid, allylsulfonic acid, sulfoethyl methacrylate, sulfopropyl methacrylate, sulfobutyl methacrylate, and other sulfonic acid group-containing compounds which do not have functional groups other than sulfonic acid groups; 2-acrylamide-2-methyl propanesulfonic acid (AMPS), and other compounds which contain amide groups and sulfonic acid groups; 3-aryloxy-2-hydroxy propanesulfonic acid (HAPS), and other compounds which contain hydroxyl groups and sulfonic acid groups; etc. may be mentioned. Further, their lithium salts, sodium salts, potassium salts, etc. may also be used. These may be used alone or in combinations of two or more types. Among these as well, 2-acrylamide-2-methyl propanesulfonic acid (AMPS) is preferable.

As specific examples of a monomer which has a phosphoric acid group, 2-acryloyloxyethyl phosphate, 2-methacryloyloxyethyl phosphate, methyl-2-acryloyloxyethyl phosphate, methyl-2-methacryloyloxyethyl phosphate, ethyl-acryloyloxyethyl phosphate, ethyl-methacryloyloxyethyl phosphate, etc. may be mentioned. These may be used alone or in combinations of two or more types. Among these as well, 2-methacryloyloxyethyl phosphate is preferable.

The ratio of content of the monomer unit which has an acidic functional group in the particle-shaped binder used in the present invention is preferably 1 to 30 wt % with respect to the total monomer units, more preferably 1 to 20 wt %, furthermore preferably 1 to 15 wt %, particularly preferably 1 to 6 wt %. By making the ratio of content of the monomer unit which has an acidic functional group in the above range, it is possible to improve the adhesion with the current collector while maintaining the flexibility of the electrode as it is.

Further, as the monomer forming the monomer unit which contains a C₄ or more linear alkylene structure forming part of the nitrile polymer which is contained in the particle-shaped binder used in the present invention, for example, a C₄ or more conjugated diene monomer may be mentioned. As specific examples of the C₄ or more conjugated diene monomer, 1,3-butadiene, isoprene, 2,3-dimethyl-1,3-butadiene, 1,3-pentadiene, chloroprene, etc. may be mentioned. Note that, a conjugated diene monomer is included in a state which has double bonds after copolymerization, but by hydrogenating the double bonds, it is possible to form monomer units which contain linear alkylene structures in the copolymer.

The ratio of content of the monomer unit which contains a C₄ or more linear alkylene structure in the particle-shaped binder used in the present invention is preferably 50 to 90 wt % with respect to the total monomer units, more preferably 50 to 80 wt %, furthermore preferably 50 to 75 wt %, particularly preferably 50 to 65 wt %. By making the ratio of content of the monomer unit which contains a C₄ or more linear alkylene structure in the above range, it is possible to impart suitable flexibility to the electrode and improve the shapeability of the electrode.

Further, the nitrile polymer which is contained in the particle-shaped binder used in the present invention may contain other monomer units in addition to the above monomer units. As the other monomer units, polymer units which are derived from other vinyl monomers may be mentioned. As such other vinyl monomers, for example, ethyleneglycol dimethacrylate, diethyleneglycol dimethacrylate, and other carboxylic acid esters which have two or more carbon-carbon double bonds; vinyl chloride, vinylidene chloride, or other halogen atom-containing monomers; vinyl acetate, vinyl propionate, vinyl butyrate, or other vinyl esters; methyl vinyl ether, ethyl vinyl ether, butyl vinyl ether, or other vinyl ethers; methyl vinyl ketone, ethyl vinyl ketone, butyl vinyl ketone, hexyl vinyl ketone, isopropenyl vinyl ketone, or other vinyl ketones; N-vinyl pyrrolidone, vinyl pyridine, vinyl imidazole, or other heterocycle-containing vinyl compounds may be mentioned.

Further, the nitrile polymer which is contained in the particle-shaped binder used in the present invention has an iodine value of 3 to 40 mg/100 mg, preferably 3 to 20 mg/100 mg, more preferably 3 to 10 mg/100 mg. If the iodine value is too high, the chemical stability with respect to a high potential ends up falling and as a result the high temperature cycle characteristics is liable to fall. On the other hand, if the iodine value falls too much, the crystallinity of the nitrile polymer ends up becoming higher. Due to this, the shapeability ends up falling. Note that, the iodine value is found in accordance with JIS K 6235 (2006).

Note that, the nitrile polymer which is contained in the particle-shaped binder used in the present invention has a particle shape, but usually it is dispersed in a particle form in water and used in a state of a dispersion. If dispersed in a particle form in water, the average particle size (dispersed particle size) of the nitrile polymer is preferably 80 to 500 nm, more preferably 80 to 400 nm, furthermore preferably 80 to 300 nm. If the average particle size of the nitrile polymer is this range, the obtained electrochemical device electrode becomes better in strength and flexibility.

Further, the nitrile polymer which is contained in the particle-shaped binder used in the present invention has a glass transition temperature (Tg) of preferably −60 to 20° C., more preferably −55 to 10° C., particularly preferably −50 to 0° C. By the glass transition temperature being in the above range, the obtained electrochemical device electrode can be made one which has excellent strength and flexibility and has a high output characteristics.

The method of production of the nitrile polymer which is contained in the particle-shaped binder used in the present invention is not particularly limited, but can be produced by polymerizing the above-mentioned monomers by the emulsion polymerization method using water as a dispersant and hydrogenating the obtained copolymer in the state dispersed in water (hydrogenation reaction).

The emulsifier used for the emulsion polymerization is not particularly limited, but any of an anionic surfactant, nonionic surfactant, and cationic surfactant may be used. The amount of addition of the emulsifier may be suitably set and is usually 0.01 to 10 parts by weight or so with respect to 100 parts by weight of the total amount of the monomers which are used for polymerization.

Further, as the polymerization initiator used for polymerization, for example, lauroyl peroxide, diisopropylperoxy dicarbonate, di-2-ethylhexylperoxy dicarbonate, t-butylperoxy pivalate, 3,3,5-trimethylhexanoyl peroxide, and other organic peroxides, α,α′-azobisisobutyronitrile, and other azo compounds, or ammonium persulfate, potassium persulfate, etc. may be mentioned.

Further, in the present invention, a nitrile polymer may be obtained by hydrogenating the copolymer obtained by emulsion polymerization as is in the state dispersed in water. In particular, in the present invention, by hydrogenating the copolymer w obtained by emulsion polymerization as is in the state dispersed in water, it is possible to obtain a particle-shaped binder dispersed in a particle form in water in the state of a dispersion. Due to this, in the composite particles for electrochemical device electrode of the present invention, it becomes possible to make the nitrile polymer be present in a state holding the particle form. Note that, the method of hydrogenation is not particularly limited. A known method may be employed.

Furthermore, the particle-shaped binder used in the present invention may contain, in addition to the above-mentioned nitrile polymer, an acrylic polymer which contains (meth)acrylic acid ester monomer units (meaning acrylic acid ester monomer units and/or methacrylic acid ester monomer units, same below) as main ingredients (below, sometimes simply referred to as “acrylic polymer”). By making the particle-shaped binder one which contains an acrylic polymer in addition to a nitrile polymer, the obtained electrochemical device electrode can be improved more in the low temperature cycle characteristics and the low temperature output characteristics.

As the (meth)acrylic acid ester monomer which forms the (meth)acrylic acid ester monomer units forming the acrylic polymer which is contained in the particle-shaped binder used in the present invention, methyl (meth)acrylate, ethyl (meth)acrylate, propyl(meth)acrylate, isopropyl(meth)acrylate, n-butyl (meth)acrylate, isobutyl(meth)acrylate, cyclohexyl(meth)acrylate, 2-ethylhexyl(meth)acrylate, isopentyl(meth)acrylate, isooctyl(meth)acrylate, isobonyl(meth)acrylate, isodecyl(meth)acrylate, lauryl(meth)acrylate, stearyl(meth)acrylate, tridecyl(meth)acrylate, or other (meth)acrylic acid alkyl esters; butoxyethyl(meth)acrylate, ethoxydiethyleneglycol(meth)acrylate, methoxydipropyleneglycol(meth)acrylate, methoxypolyethyleneglycol(meth)acrylate, phenoxyethyl(meth)acrylate, tetrahydrofurfuryl(meth)acrylate, or other ether group-containing (meth)acrylic acid esters; 2-hydroxyethyl(meth)acrylate, 2-hydroxypropyl(meth)acrylate, 2-hydroxy-3-phenoxypropyl(meth)acrylate, 2-(meth)acryloyloxyethyl-2-hydroxyethyl phthalic acid, or other hydroxyl group-containing (meth)acrylic acid esters; 2-(meth)acryloyloxyethyl phthalic acid, 2-(meth)acryloyloxyethyl phthalic acid, or other carboxylic acid-containing (meth)acrylic acid esters; perfluorooctylethyl(meth)acrylate or other fluorine group-containing (meth)acrylic acid esters; phosphoric acid ethyl (meth)acrylate or other phosphoric acid group-containing (meth)acrylic acid esters; glycidyl(meth)acrylate or other epoxy group-containing (meth)acrylic acid esters; dimethylaminoethyl(meth)acrylate or other amino group-containing (meth)acrylic acid esters; etc. may be mentioned.

These (meth)acrylic acid esters may be used alone or in combinations of two or more types. Among these as well, it is possible to make the acrylic polymer one which is low in swellability with respect to the electrolytic solution. Due to this, it is possible to improve the cycle characteristics when made into an electrode. From this viewpoint, a (meth)acrylic acid alkyl ester is preferable, methyl acrylate, ethyl acrylate, propyl acrylate, n-butyl acrylate, 2-ethylhexyl acrylate, and isopentyl acrylate are more preferable, ethyl acrylate, n-butyl acrylate, and 2-ethylhexyl acrylate are furthermore preferable, and 2-ethylhexyl acrylate is particularly preferable.

The ratio of content of the (meth)acrylic acid ester units in the acrylic polymer which is contained in the particle-shaped binder used in the present invention is preferably 40 to 99 wt %, more preferably 50 to 90 wt %, furthermore preferably 70 to 85 wt %. By making the ratio of content of the (meth)acrylic acid ester units in the above range, it is possible to improve the ability of the acrylic polymer to hold the electrolytic solution. Due to this, it is possible to make the high temperature cycle characteristics and low temperature cycle characteristics better when made into an electrochemical device electrode.

Further, the acrylic polymer which is contained in the particle-shaped binder which is used in the present invention may be a copolymer of the above-mentioned (meth)acrylic acid ester and a monomer which can copolymerize with the same. As such a copolymerizable monomer, for example, a nitrile group-containing monomer, a monomer which has an acidic functional group, etc. may be mentioned.

As the nitrile group-containing monomer, a monomer similar to the above-mentioned nitrile polymer may be used. The ratio of content of the nitrile group-containing monomer unit in the acrylic polymer is preferably 30 wt % or less, more preferably 3 to 25 wt %, still more preferably 5 to 20 wt %. By making the ratio of content of the nitrile group-containing monomer unit the above range, it is possible to raise more the bonding force of the binder. Due to this, it is possible to make the high temperature cycle characteristic and the low temperature cycle characteristic when made into an electrochemical device electrode better.

Similarly, as the monomer which has an acidic functional group, a monomer similar to the above-mentioned nitrile polymer can be used. The ratio of content of the monomer unit which has an acidic functional group in the acrylic polymer is preferably 0.5 to 10 wt %, more preferably 1 to 8 wt %, furthermore preferably 1 to 6 wt %. By making the ratio of content of the monomer unit which has an acidic functional group in the above range, it is possible to further improve the adhesion with the current collector while maintaining the flexibility of the electrode as it is.

Furthermore, the acrylic polymer may be copolymerized with other monomers which can copolymerize with the above-mentioned monomers. As such other monomers, for example, carboxylic acid esters which have two or more carbon-carbon double bonds, aromatic vinyl-based monomers, amide-based monomers, olefins, diene-based monomers, vinyl ketones, heterocycle-containing vinyl compounds, etc. may be mentioned.

Note that, the acrylic polymer which is contained in the particle-shaped binder used in the present invention has a particle shape, but usually it is dispersed in a particle form in water and used in a state of a dispersion. When dispersed in a particle form in water, the acrylic polymer has an average particle size (dispersed particle size) of preferably 50 to 500 nm, more preferably 70 to 400 nm, furthermore preferably 90 to 250 nm. If the acrylic polymer has an average particle size in this range, the obtained electrochemical device electrode becomes excellent in strength and flexibility.

The method of production of the acrylic polymer used in the present invention is not particularly limited, but the method of polymerizing the above-mentioned monomers by the emulsion polymerization method using water as a dispersant is preferable. As the emulsifier and polymerization initiator which is used for emulsion polymerization, it is possible to use ones similar to the above-mentioned nitrile polymer.

The ratio of content of the particle-shaped binder in the composite particles for electrochemical device electrode of the present invention is preferably 0.1 to 15 parts by weight with respect to 100 parts by weight of the electrode active material, more preferably 0.5 to 10 parts by weight, furthermore preferably 1 to 10 parts by weight. By making the ratio of content of the particle-shaped binder in the above range, when made into an electrode, it is possible to sufficiently secure ion conduction while obtaining sufficient bonding force between electrode active material particles and adhesion between the electrode active material layer and the current collector.

Note that, when making the particle-shaped binder used in the present invention one which contains the acrylic polymer in addition to the nitrile polymer, the ratio of content of the monomer units which form the nitrile polymer is preferably made in the following range.

That is, the ratio of content of the nitrile group-containing monomer unit which forms part of the nitrile polymer is 10 to 50 wt % with respect to the total monomer units, preferably 10 to 40 wt %, more preferably 15 to 35 wt %, furthermore preferably 30 to 40 wt %. Further, the ratio of content of the monomer unit which has an acidic functional group which forms part of the nitrile polymer is preferably 0.05 to 10 wt % with respect to the total monomer units, more preferably 0.1 to 8 wt %, furthermore preferably 1 to 6 wt %. Note that, the ratio of content of the monomer unit which contains a C₄ or more linear alkylene structure may be made in the above-mentioned range. Further, when making the particle-shaped binder used in the present invention one which contains the acrylic polymer in addition to the nitrile polymer, the iodine value of the nitrile polymer is 3 to 40 mg/100 mg, preferably 3 to 15 mg/100 mg, more preferably 3 to 9 mg/100 mg, while the average particle size (dispersed particle size) of the nitrile polymer should be made in the above-mentioned range.

Note that, when using as the particle-shaped binder used in the present invention one which does not contain the acrylic polymer, that is, when using only the nitrile polymer or when using the nitrile polymer in combination with a polymer other than the acrylic polymer, making the ratio of content of the monomer units which form the nitrile polymer, the iodine value, and average particle size (dispersed particle size) are preferably made in the above-mentioned ranges.

When making the particle-shaped binder used in the present invention one which contains the acrylic polymer in addition to the nitrile polymer, the ratio of the nitrile polymer in the particle-shaped binder is preferably 10 to 90 wt % with respect to 100 wt % of the particle-shaped binder as a whole, more preferably 20 to 80 wt %, furthermore preferably 30 to 70 wt %. Further, the ratio of content of the nitrile polymer with respect to 100 parts by weight of the electrode active material is preferably 0.1 to 2 parts by weight, more preferably 0.2 to 1.8 parts by weight, furthermore preferably 0.5 to 1.5 parts by weight. By making the ratio of content of the nitrile polymer in the above range, it is possible to make the bonding force of the binder sufficient and thereby possible to make the high temperature cycle characteristics and the low temperature cycle characteristics better when made into an electrochemical device electrode.

Further, when making the particle-shaped binder used in the present invention one which contains the acrylic polymer in addition to the nitrile polymer, the ratio of content of the acrylic polymer in the particle-shaped binder is preferably 10 to 90 wt % with respect to 100 wt % of the particle-shaped binder as a whole, more preferably 20 to 80 wt %, furthermore preferably 30 to 70 wt %. Note that, the ratio of content of the acrylic polymer with respect to 100 wt % of the electrode active material is preferably 0.1 to 2 parts by weight, more preferably 0.2 to 1.8 parts by weight, furthermore preferably 0.5 to 1.5 parts by weight. By making the ratio of content of the acrylic polymer in the above range, it is possible to make the bonding force of the binder sufficient and thereby possible to make the high temperature cycle characteristics and the low temperature cycle characteristics better when made into an electrochemical device electrode.

Furthermore, when making the particle-shaped binder used in the present invention one which contains the acrylic polymer in addition to the nitrile polymer, the iodine value of the total binder ingredients which form the particle-shaped binder (that is, for example, when particle-shaped binder used in the present invention contains only the nitrile polymer and acrylic polymer in predetermined ratios, the iodine value when mixing the nitrile polymer and the acrylic polymer in that above predetermined ratio) is preferably 3 to 30 mg/100 mg, more preferably 3 to 20 mg/100 mg, furthermore preferably 3 to 10 mg/100 mg. If the iodine value of the particle-shaped binder is too high, the chemical stability with respect to a high potential ends up falling and as a result the high temperature cycle characteristics is liable to fall. On the other hand, if the iodine value is too low, the crystallinity of the binder ends up becoming high and thereby the shapeabiity is liable to end up falling.

Further, when making the particle-shaped binder used in the present invention one which contains the acrylic polymer in addition to the nitrile polymer, the ratio of content of the nitrile group-containing monomer unit in the total ingredients as a whole is preferably 5 to 35 wt %, more preferably 10 to 30 wt %, furthermore preferably 15 to 25 wt % in range. By making the ratio of content of the nitrile group-containing monomer unit the above range, it is possible to prevent the mechanical strength of the binder from falling and make the adhesion excellent.

Note that, the particle-shaped binder used in the present invention may contain a polymer ingredient other than the above-mentioned nitrile polymer and acrylic polymer.

(Antioxidant)

The composite particles for electrochemical device electrode of the present invention may contain an antioxidant in addition to the above ingredients. In particular, from the viewpoint that, when using as the above-mentioned particle-shaped binder one which contains the acrylic polymer in addition to the nitrile polymer, the obtained electrochemical device electrode can be made particularly excellent in low temperature cycle characteristics and low temperature output characteristics and, further, can be improved in oxidation resistance of the binder, in this case, including an antioxidant is preferable. In particular, by improving the oxidation resistance of the binder, this can be suitably used as a material forming part of the positive electrode of an electrochemical device.

The antioxidant used in the present invention is not particularly limited, but, for example, a phenol-based antioxidant, amine-based antioxidant, quinone-based antioxidant, organic phosphorus-based antioxidant, sulfur-based antioxidant, phenothiazine-based antioxidant, etc. may be mentioned. Among these as well, from the viewpoint of the effect of improvement of the cycle characteristics of the cell and the difficulty of reaction with the electrolytic solution or lithium salt and surface functional groups of the electrode active material, etc. and therefore the ability of receptivity for lithium at the low temperature to be greatly improved by surface treatment of the electrode active material, a phenol-based antioxidant and an amine-based antioxidant are preferable, and an amine-based antioxidant is more preferable. In the present invention, by adding an antioxidant to the composite particles for electrochemical device electrode, it is possible to effectively prevent the binder from deteriorating due to oxidation when made into an electrochemical device electrode. Due to this, it is possible to make the high temperature cycle characteristics and the low temperature cycle characteristics better.

As the phenol-based antioxidant, for example, 3,5-di-t-butyl-4-hydroxytoluene, dibutylhydroxytoluene, 2,2′-methylenebis(6-t-butyl-4-methylphenol), 4,4′-butylidene bis(3-t-butyl-3-methylphenol), 4,4′-thiobis(6-t-butyl-3-methylphenol), α-tocophenol, 2,2,4-trimethyl-6-hydroxy-7-t-butylchromane, etc. may be mentioned. These may be used as single type alone or as a plurality of types combined.

As the amine-based antioxidant, for example, bis(4-t-butylphenyl)amine, poly(2,2,4-trimethyl-1,2-dihydroquinoline), 6-ethoxy-1,2-dihydro-2,2,4-trimethylquinoline, a reaction product of diphenylamine and acetone, 1-(N-phenylamino)-naphthalene, diphenylamine derivative, dialkyldiphenylamines, N,N′-diphenyl-β-phenylene diamine, mixed diallyl-β-phenylene diamine, N-phenyl-N′-isopropyl-β-phenylene diamine, N,N′-di-2-naphthyl-β-phenylene diamine compound, compounds expressed by the following general formula (1), compounds expressed by the following general formula (3), etc. may be mentioned. These may be used as single type alone or as a plurality of types combined. Among these as well, bis(4-t-butylphenyl)amine, compounds expressed by the following general formula (1), and compounds expressed by the following general formula (3) are preferable, compounds expressed by the following general formula (1) and compounds expressed by the following general formula (3) are more preferable, and compounds expressed by the following general formula (1) are particularly preferable.

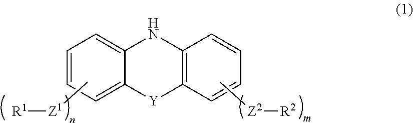

In the above general formula (1), Y indicates a chemically single bond or —SO₂—, preferably —SO₂—.

In the above general formula (1), R¹ and R² respectively independently indicate a C₁ to C₃₀ organic group which may have substituent. As R¹ and R², respectively independently, a C₂ to C₂₀ alkyl group which may have substituent or C₆ to C₂₀ aryl group which may have substituent is preferable, a linear or branched C₂ to C₂₀ alkyl group which may have substituent, a phenyl group which may have substituent or a naphthyl group which may have substituent is more preferable, a linear or branched C₂ to C₈ alkyl group which may have substituent or a phenyl group which may have substituent is furthermore preferable, and a linear or branched C₂ to C₈ alkyl group which may have substituent is particularly preferable.

As preferable specific examples of the organic groups which form this R¹ and R², an α-methylbenzyl group, α,α-dimethylbenzyl group, t-butyl group, phenyl group, 4-methylphenyl group, etc. may be mentioned. Among these as well, an α,α-dimethylbenzyl group or 4-methylphenyl group is more preferable, while an α,α-dimethylbenzyl group is furthermore preferable. Note that, these may be made independent.

Further, in the above general formula (1), Z¹ and Z² respectively independently indicate a chemically single bond or —SO₂—. Z¹ and Z² preferably are chemically single bonds.

Furthermore, in the above general formula (1), n and m respectively independently indicate 0 or 1, where at least one of n and m is 1. Note that, n and m both being 1 is preferable.

Further, in the present invention, among the compounds which are expressed by the above general formula (1) as well, the compounds which are expressed by the following general formula (2) are preferable.

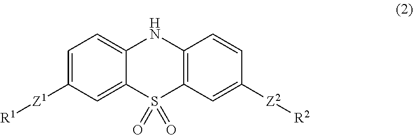

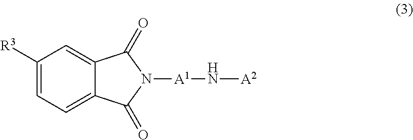

In the above formula (3), A¹ and A² respectively independently indicate a C₁ to C₃₀ aromatic group which may have substituent, A¹ is preferably a C₁ to C₃₀ phenylene group which may have substituent, and, further, A² is a C₁ to C₃₀ phenyl group which may have substituent.

In the above formula (3), R³ indicates a hydrogen atom, halogen atom, or C₁ to C₁₀ alkyl group which may have substituent, cyano group, nitro group, —O—C(C═O)—R′, —C(═O)—OR′, —NR′″—C(═O)—R′, —C(C═O)—NR′R″, or —O—C(C═O)—NR′R″.

Note that, R′ and R″ respectively independently indicate a C₁ to C₃₀ organic group which may have substituent. As organic groups, at least one type of connecting group which is selected from the group comprised of —O—, —S—, —O—C(O)—, —C(O)—O—, —O—C(O)—O—, —NR″″—C(C═O)—, —C(O)—NR″″—, —NR″″—, and —C(C═O)— may be interposed. Note that, R″″ is a C₁ to C₆ alkyl group which may have substituent.

Further, R′″ is a substituted or unsubstituted C₁ to C₆ alkyl group which may have substituent.

Note that, as R³, —C(C═O)—OR′ is preferable. Further, in this case, R′ is preferably a C₁ to C₂₀ aromatic group which may have substituent, particularly preferably a C₁ to C₁₈ phenyl group which may have substituent.

In the composite particles for electrochemical device electrode of the present invention, the ratio of content of the antioxidant is preferably 0.05 to 3 parts by weight with respect to 100 parts by weight of the particle-shaped binder, more preferably 0.05 to 22.5 parts by weight, furthermore preferably 0.2 to 2 parts by weight. By making the ratio of content of the antioxidant in the above range, it is possible to prevent a drop in the adhesion with the current collector while effectively preventing deterioration by oxidation of the particle-shaped binder. Due to this, it is possible to further improve the high temperature cycle characteristics, the low temperature cycle characteristics, and internal resistance.

(Conductive Material)

The composite particles for electrochemical device electrode of the present invention may contain a conductive material if necessary in addition to the above ingredients.

The conductive material is not particularly limited so long as a particle-shaped material which has conductivity, but, for example, furnace black, acetylene black, ketjen black, or other conductive carbon blacks; natural graphite, artificial graphite, or other graphites; or polyacrylonitrile-based carbon fiber, pitch-based carbon fiber, carbon fiber obtained by vapor phase method, or other carbon fibers; may be mentioned. The average particle size of the conductive material is not particularly limited, but is preferably smaller than the average particle size of the electrode active material and is usually 0.001 to 10 μm, more preferably 0.05 to 5 μm, furthermore preferably 0.01 to 1 μm in range. If the average particle size of the conductive material is in the above range, it is possible to express sufficient conductivity by a smaller amount of use.

The ratio of content of the conductive material in the composite particles for electrochemical device electrode of the present invention is preferably 0.1 to 50 parts by weight with respect to 100 parts by weight of the electrode active material, more preferably 0.5 to 15 parts by weight, furthermore preferably 1 to 10 parts by weight. By making the ratio of content of the conductive material in the above range, it becomes possible to maintain the capacity of the obtained electrochemical device high while sufficiently reducing the internal resistance.

(Dispersant)

Further, the composite particles for electrochemical device electrode of the present invention may contain, in addition to the above ingredients, a dispersant in accordance with need. The dispersant is an ingredient which has the action of making the ingredients uniformly disperse in a solvent when making the ingredients which form the composite particles for electrochemical device electrode of the present invention disperse or dissolve in a solvent to prepare a slurry. As the dispersant, for example, carboxymethyl cellulose, methyl cellulose, ethyl cellulose, hydroxypropyl cellulose, and other cellulose-based polymers and ammonium salts or alkali metal salts of the same; sodium poly(meth)acrylate and other poly(meth)acrylic acid salts; polyvinyl alcohol, modified polyvinyl alcohol, polyethyleneoxide; polyvinyl pyrrolidone, polycarboxylic acid, starch oxide, starch phosphate, casein, various modified starches, chitin, chitosan derivatives, etc. may be mentioned. These dispersants may be used alone or as two or more types combined. Among these as well, a cellulose-based polymer is preferable, carboxymethyl cellulose or its ammonium salt or alkali metal salt is particularly preferable.

The ratio of content of the dispersant in the composite particles for electrochemical device electrode of the present invention is preferably 0.1 to 50 parts by weight with respect to 100 parts by weight of the electrode active material, more preferably 0.5 to 10 parts by weight, furthermore preferably 0.8 to 2 parts by weight. By making the ratio of content of the dispersant in the above range, it is possible to make the ingredients disperse well in the slurry.

(Composite Particles for Electrochemical Device Electrode)

The composite particles of the present invention contain an electrode active material, particle-shaped binder, and, in accordance with need, an antioxidant, conductive material, and dispersant, but these are not present as individually independent particles. At least two ingredients of these ingredients, preferably all ingredients, form single particles.

Specifically, preferably pluralities of the individual particles of the different ingredients bond together to form secondary particles and pluralities (preferably several to several dozen of) particles of the electrode active material are bonded by the particle-shaped binder to form masses of particles.

Further, the composite particles for electrochemical device electrode are not particularly limited in shape and structure, but from the viewpoint of the fluidity, the shape is preferably one close to a sphere. The structure is preferably one where the particle-shaped binder are not segregating at the surface of the composite particles, but are uniformly dispersed in the composite particles.

The method of production of the composite particles for electrochemical device electrode of the present invention is not particularly limited, but according to the spray drying granulation method which is explained below, the composite particles for electrochemical device electrode of the present invention can be obtained relatively easily, so this is preferable. Below, the spray drying granulation method will be explained.

First, a slurry for composite particles which contains an electrode active material, particle-shaped binder, and, in accordance with need, an antioxidant, conductive material, and dispersant is prepared. The slurry for composite particles may be prepared by making the electrode active material, particle-shaped binder, and, in accordance with need, antioxidant, conductive material, and dispersant disperse or dissolve in a solvent. Note that, in this case, when the particle-shaped binder (nitrile polymer or acrylic polymer) is dispersed in a dispersion medium constituted by water, it may be added in a state dispersed in water. Further, when the dispersant is dispersed in water in state, it may be added in the state dissolved in water.

As the solvent used to obtain the slurry for composite particles, usually water is used, but it is also possible to use a mixed solvent of water and an organic solvent. As the organic solvent which can be used in this case, for example, methyl alcohol, ethyl alcohol, propyl alcohol, or other alkyl alcohols; acetone, methylethylketone, or other alkylketones; tetrahydrofuran, dioxane, diglyme, or other ethers; diethyl formamide, dimethyl acetoamide, N-methyl-2-pyrrolidone, dimethyl imidazolidinone, or other amides; dimethyl sulfoxides, sulfolane, or other sulfur-based solvents; etc. may be mentioned. Among these, alcohols are preferable. By jointly using water and an organic solvent with a boiling point lower than water, it is possible to accelerate the drying speed at the time of spray drying.

The amount of the solvent which is used for preparing the slurry for composite particles is one which gives a solid content concentration in the slurry for composite particles of preferably 1 to 50 wt %, more preferably 5 to 50 wt %, furthermore preferably 10 to 30 wt % in range. By making the solid content concentration in the above range, it is possible to uniformly disperse the non-water soluble particle-shaped polymer, so this is preferable.

Further, the viscosity of the slurry for composite particles is, at room temperature, preferably 10 to 3,000 mPa·s, more preferably 30 to 1,500 mPa·s, furthermore preferably 50 to 1,000 mPa·s in range. If the viscosity of the slurry for composite particles is in this range, it is possible to raise the productivity of the process of spray drying granulation.

Further, in the present invention, when preparing the slurry for composite particles, it is possible to add a surfactant in accordance with need.

As the surfactant, an anionic, cationic, nonionic, nonionic anion, or other amphoteric surfactant may be mentioned, but an anionic or nonionic surfactant which easily breaks down under heat is preferable. The amount of the surfactant is preferably 50 parts by weight or less with respect to 100 parts by weight of the electrode active material, more preferably 0.1 to 10 parts by weight, furthermore preferably 0.5 to 5 parts by weight.

The method or order of dispersing or dissolving the electrode active material, particle-shaped binder, and, in accordance with need, the antioxidant, conductive material, and dispersant in a solvent is not particularly limited. Further, as the mixing device, for example, a ball mill, sand mill, beads mill, pigment disperser, stone mill, ultrasonic disperser, homogenizer, homomixer, planetary mixer, etc. can be used. The mixing is usually performed at room temperature to 80° C. in range for 10 minutes to several hours.

Next, the obtained slurry for composite particles was granulated by spray drying. Spray drying is a method of spraying a slurry in hot air to dry it. As the device which is used for spraying the slurry, an atomizer may be mentioned. As an atomizer, two types of devices of a rotary disk system and a pressurizing system may be mentioned. The rotary system type is a system which introduces the slurry at the approximate center of a disk which is rotating at a high speed, uses the centrifugal force of the disk to fling the slurry to the outside of the disk, and atomizes the slurry at that time. In the rotary disk type, the rotational speed of the disk depends on the size of the disk, but is usually 5,000 to 30,000 rpm, preferably 15,000 to 30,000 rpm. The lower the rotational speed of the disk, the larger the sprayed drops and the greater the average particle size of the obtained composite particles for electrochemical device electrode. As the rotary disk type atomizer, the pin type and the vane type may be mentioned, but a pin type atomizer is preferable. The pin type atomizer is one type of centrifugal atomizer which uses a spray disk. The spray disk is configured by a top and bottom mounting disk between which a plurality of spray rollers are detachably attached on a substantially concentric circle along their circumferential edges. The slurry for composite particles is introduced from the center of the spray disk, deposits on the spray rollers by centrifugal force, passes over the roller surfaces to the outside, and finally detaches from the roller surfaces and is sprayed outward. On the other hand, the pressurized system is a system which pressurizes the slurry for composite particles and sprays it from a nozzle to dry it.

The temperature of the slurry for composite particles which is sprayed is usually room temperature, but it may also be made a temperature higher than room temperature by heating. Further, the hot air temperature at the time of spray drying is usually 80 to 250° C., preferably 100 to 200° C. In the spray drying method, the method of blowing in the hot air is not particularly limited. For example, the system where the hot air and spray directions are concurrent in the horizontal direction, the system where the slurry is sprayed at the top part of the drying tower and descends together with the hot air, the system where the sprayed drops and hot air contact countercurrently, the system where the sprayed drops flow concurrently with the initial hot air then descend by gravity and contact it countercurrently, etc. may be mentioned.

Note that, as the atomization method, other than the method of spraying all at once the slurry for composite particles which contains the electrode active material, particle-shaped binder, and, in accordance with need, an antioxidant, conductive material, and dispersant, it is also possible to use the method of spraying a slurry which contains the particle-shaped binder and, in accordance with need, an antioxidant, conductive material, and dispersant on a flowing electrode active material. The optimum method for the ingredients of the composite particles etc. should be suitably selected from the viewpoint of the ease of control of the particle size, the ability to reduce the particle size distribution, etc.

The composite particles for electrochemical device electrode of the present invention which are obtained in this way have an average particle size of preferably 0.1 to 1,000 μm, more preferably 1 to 80 μm, furthermore preferably 10 to 70 μm. By making the average particle size in the above range, it is possible to increase more the fluidity of the composite particles for electrochemical device electrode. Note that, the average particle size of the composite particles for electrochemical device electrode is the volume average size which is measured by a laser diffraction particle size measurement device (for example, SALD-3100; made by Shimadzu Corporation) and calculated.

(Electrochemical Device Electrode Material)

The material for electrochemical device electrode of the present invention includes the above-mentioned composite particles for electrochemical device electrode of the present invention. The composite particles for electrochemical device electrode of the present invention are used alone or with the inclusion of another binder or other additive according with need as the material for electrochemical device electrode. The content of the composite particles for electrochemical device electrode which is included in the material for electrochemical device electrode is preferably 50 wt % or more, more preferably 70 wt % or more, furthermore preferably 90 wt % or more.

As another binder which is used according with need, for example, it is possible to use the particle-shaped binder which is contained in the above-mentioned composite particles for electrochemical device electrode of the present invention. The composite particles for electrochemical device electrode of the present invention already contain the binder constituted by the particle-shaped binder, so when preparing the material for electrochemical device electrode, there is no need to separately add another binder, but another binder may also be added to raise the bonding force between composite particles for electrochemical device electrode. Further, the amount of addition of the other binder when adding another binder is, by total with the particle-shaped binder in the composite particles for electrochemical device electrode, preferably 0.01 to 10 parts by weight with respect to 100 parts by weight of the electrode active material, more preferably 0.1 to 5 parts by weight. Further, as the other additives, water or alcohol and other shaping aids etc. may be mentioned. These may be suitably selected and added in amounts not detracting from the effect of the present invention.

(Electrochemical Device Electrode)

The electrochemical device electrode of the present invention is comprised of an active material layer comprised of the above-mentioned material for electrochemical device electrode of the present invention laminated on a current collector. As the material for current collector, for example, a metal, carbon, conductive polymer, etc. can be used. Preferably, a metal is used. As the metal, usually, copper, aluminum, platinum, nickel, tantalum, titanium, stainless steel, and alloys etc. may be used. Among these, from the viewpoint of the conductivity and voltage resistance, copper, aluminum or an aluminum alloy is preferably used. Further, when a high voltage resistance is required, it is possible to suitably use the high purity aluminum which is disclosed in Japanese Patent Publication No. 2001-176757A etc. The current collector is a film or sheet shape. The thickness is suitably selected in accordance with the objective of use, but is usually 1 to 200 μm, preferably 5 to 100 μm, more preferably 10 to 50 μm.

When laminating the active material layer on the current collector, the active material constituted by the material for electrochemical device electrode may be made a sheet shape and then laminated on the current collector, but the method of directly press forming the material for electrochemical device electrode on the current collector is preferable. As the press forming, for example, the method of using a roll type press forming apparatus which is provided with a pair of rolls, feeding the current collector by the rolls while feeding the material for electrochemical device electrode by a screw feeder or other feed device to a roll type press forming apparatus so as to form an active material layer on the current collector, the method of sprinkling the material for electrochemical device electrode over the current collector, smoothing the material for electrochemical device electrode by a blade etc. to adjust the thickness, then pressing it by a press device, the method of filling the material for electrochemical device electrode in a mold and pressing the mold to shape it, etc. may be mentioned. Among these, the roll forming method is preferable. In particular, the composite particles for electrochemical device electrode of the present invention have a high fluidity, so due to the high fluidity, it is possible to shape the material by roll press forming. Due to this, the productivity can be improved.

The temperature at the time of roll press forming is preferably 0 to 200° C., more preferably is a temperature 20° C. or more higher than the glass transition temperature of the particle-shaped binder. By making the temperature at the time of roll press forming in the above range, it is possible to make the adhesion between the active material layer and the current collector sufficient. Further, the press linear pressure between the rolls at the time of roll press forming is preferably 0.2 to 30 kN/cm, more preferably 1.5 to 15 kN/cm. By making the linear pressure in the above range, it is possible to improve the uniformity of the thickness of the active material. Further, the forming speed at the time of roll press forming is preferably 0.1 to 20 m/min, more preferably 4 to 10 m/min.

Further, to eliminate the fluctuations in thickness in the electrochemical device electrode which is formed and raise the density of the electrode active material layer to increase the capacity, it is also possible to post-press the electrode if necessary. The method of post-pressing is generally pressing by a roll. In the roll press process, two cylindrical rolls are arranged in parallel at the top and bottom across a narrow distance and made to rotate in opposite directions and the electrode is taken in between them to be pressed. At this time, it is possible to heat or cool or otherwise adjust the temperature of this in accordance with need.

The electrochemical device electrode of the present invention obtained in this way is obtained by using the above-mentioned composite particles for electrochemical device electrode of the present invention for the active material layer, so the adhesion between the active material layer and the current collector is high, the internal resistance is low, and the cycle characteristics is excellent. Further, according to the present invention, the composite particles for electrochemical device electrode of the present invention may be used to form the electrode active material layer by powder forming without using water or an organic solvent and other dispersion medium or solvent, so it is possible to effectively prevent the occurrence of trouble like in the case of using the coating method which is used in the past such as the binder ending up segregating in the electrode active material layer and thereby the internal resistance ending up becoming higher or trouble of the aluminum current collector ending up corroding and the shapeability and cell characteristics ending up falling even when using a compound which contains nickel as a positive electrode active material.

Further, in the present invention, when including the acrylic polymer in addition to the nitrile polymer as the particle-shaped binder, it becomes possible to better improve the low temperature cycle characteristics and the low temperature output characteristics of the obtained electrochemical device electrode in addition to the above characteristics. Furthermore, in the present invention, as the particle-shaped binder, one which contains the acrylic polymer in addition to the nitrile polymer is used and, in addition, an antioxidant is used jointly, it is possible to improve the oxidation resistance of the binder. For this reason, in this case, the electrochemical device electrode of the present invention may be suitably used as the positive electrode of an electrochemical device, in particular, as a positive electrode obtained using an electrode active material constituted by a composite oxide which contains lithium and nickel or other high capacity electrode active material.

(Electrochemical Device)

The electrochemical device of the present invention is provided with electrochemical device electrode of the present invention. As the electrochemical device, a lithium ion secondary cell, electric double-layer capacitor, hybrid capacitor, etc. may be mentioned.

The electrochemical device of the present invention, for example, can be obtained by using the electrochemical device electrode of the present invention as the positive electrode and/or negative electrode, sandwiching the separator between the positive electrode and the negative electrode in accordance with need, and sealing in a predetermined electrolytic solution.

### EXAMPLES

Below, examples and comparative examples will be given to explain the present invention more specifically. In the examples, “parts” and “%” are based on weight unless indicated otherwise. Note that, the definitions of the properties and the methods of evaluation are as follows.

<Iodine Value>

An aqueous dispersion of the particle-shaped binder 100 g was coagulated by 1 liter of methanol, then dried in vacuo at 60° C. for 12 hours. The iodine value of the obtained dried polymer was measured in accordance with JIS K 6235 (2006).

<Peel Strength>

The positive electrode which were obtained in the examples and comparative examples was fastened with the positive electrode active material layer surface facing up, cellophane tape was adhered to the surface of the positive electrode active material layer, then the cellophane tape was peeled off from one end of the test piece by a speed of 50 mm/min in a 180° direction, and the stress at that time was measured. Further, this measurement was performed 10 times, the average value was found, and that was used as the peel strength. The higher the peel strength, the higher the adhesion strength in the positive electrode active material layer and the adhesion strength between the positive electrode active material layer and the current collector can be judged. Note that, the peel strength was evaluated based on the following criteria in Examples 1-1 to 1-8 and Comparative Examples 1-1 to 1-8.

A: Peel strength of 10 N/m or more

B: Peel strength of less than 10 N/m to 5 N/m

C: Peel strength of less than 5 N/m to 1 N/m

D: Peel strength of less than 1 N/m

Further, they were evaluated based on the following criteria in Examples 2-1 to 2-17.

A: Peel strength of 12 N/m or more

B: Peel strength of less than 12 N/m to 8 N/m

C: Peel strength of less than 8 N/m to 5 N/m

D: Peel strength of less than 5 N/m

<Shapeability>

The positive electrode which was obtained in the examples and comparative examples was cut to 10 cm in the width direction (TD direction) and 1 m in the length direction (MD direction). The cut positive electrode was measured for film thickness equally at three points in the TD direction and equally at five points in the MD direction for a total of 15 points (=3 points×5 points). The average value A of the film thickness and the value B furthest from the average value were found. Further, from the average value A and furthest value B, the uneven thickness was calculated in accordance with the following formula (1). The following criteria were used to evaluate the shapeability. The smaller the uneven thickness, the better the shapeabiity that can be judged.

Uneven thickness(%)=(|A−B|)×100/A (1)

A: Uneven thickness of less than 5%

B: Uneven thickness of 5% to less than 10%

C: Uneven thickness of 10% to less than 15%

D: Uneven thickness of 15% or more

<Internal Resistance>

The coin type lithium ion secondary cell which was obtained in the examples and comparative examples was allowed to stand for 24 hours after fabrication of the cell, then charged at room temperature up to 4.2V by the constant current method by a charging rate of 0.1C, then was discharged in a −30° C. environment by a constant current of 0.1C and measured for the amount of voltage drop (ΔV) after 10 seconds from the start of discharge to evaluate the internal resistance. The smaller the value of the amount of voltage drop after 10 seconds from the start of discharge, the smaller the internal resistance and more possible high speed charging and discharge can be judged.

A: Voltage drop of less than 0.2V

B: Voltage drop of 0.2V to less than 0.3V

C: Voltage drop of 0.3V to less than 0.5V

D: Voltage drop of 0.5V to less than 0.7V

E: Voltage drop of 0.7V or more

<High Temperature Cycle Characteristics>

The coin type lithium ion secondary cell which was obtained in the examples and comparative examples was charged until 4.3V by the constant current method using a charging rate of 0.2C under conditions of a temperature 60° C., then was discharged to 3.0V by a discharge rate of 0.1C in a charging/discharging test repeatedly for 50 cycles. Further, the ratio of the discharge capacity Cap₅ₜₕ at the fifth charging/discharging test and the discharge capacity Cap₅₀ₜₕ at the 50th charging/discharging test ((Cap₅₀ₜₕ/Cap₅ₜₕ)×100%), that is, the 50 cycle capacity retention rate, was found. Further, the obtained 50 cycle capacity retention rate was used as the basis to evaluate the high temperature cycle characteristics by the following criteria. Note that, the higher the capacity retention rate at 50 cycles, the smaller the deterioration at the 50th cycle when performing the cycle tests at high temperature and the better the high temperature cycle characteristics that can be judged, so the more preferable.

A: Capacity retention rate at 50 cycles of 80% or more

B: Capacity retention rate at 50 cycles of 70% to less than 80%

C: Capacity retention rate at 50 cycles of 50% to less than 70%

D: Capacity retention rate at 50 cycles of 30% to less than 50%

E: Capacity retention rate at 50 cycles of less than 30%

<Low Temperature Cycle Characteristics>

The coin type lithium ion secondary cell which was obtained in Examples 2-1 to 2-17 among the examples and comparative examples was charged up to 4.3V by the constant current method using a charging rate of 0.2C under conditions of a temperature −20° C., then was discharged to 3.0V by a discharge rate of 0.1C in a charging/discharging test repeatedly for 50 cycles. Further, the ratio of the discharge capacity Cap₅ₜₕ at the fifth charging/discharging test and the discharge capacity Cap₅₀ₜₕ at the 50th charging/discharging test ((Cap₅₀ₜₕ/Cap₅ₜₕ)×100%), that is, the 50 cycle capacity retention rate, was found. Further, the obtained 50 cycle capacity retention rate was used as the basis to evaluate the low temperature cycle characteristics by the following criteria. Note that, the higher the capacity retention rate at 50 cycles, the smaller the deterioration at the 50th cycle when performing the cycle tests at low temperature and the better the low temperature cycle characteristics that can be judged, so the more preferable. Note that, the low temperature cycle characteristics was evaluated only for Examples 2-1 to 2-17 among the examples and comparative examples.

A: Capacity retention rate at 50 cycles of 80% or more

B: Capacity retention rate at 50 cycles of 70% to less than 80%

C: Capacity retention rate at 50 cycles of 50% to less than 70%

D: Capacity retention rate at 50 cycles of 30% to less than 50%

E: Capacity retention rate at 50 cycles of less than 30%

<Low Temperature Output Characteristics>

The coin type lithium ion secondary cell which was obtained in Examples 2-1 to 2-17 among the examples and comparative examples was allowed to stand in a 25° C. environment for 24 hours, then charged up to 4.2V by a charging rate of 1C under a 25° C. environment. After this, it was discharged by a discharge rate of 1C under a −10° C. environment and was measured for voltage “V” after 15 seconds from the start of discharge. The output characteristics was evaluated by the voltage change shown by ΔV=4.2V−V. The smaller this value, the better the output characteristics shown. Note that, the low temperature output characteristics was evaluated only for Examples 2-1 to 2-17 among the examples and comparative examples.

A: Voltage drop ΔV of 100 mV to less than 120 mV

B: Voltage drop ΔV of 120 mV to less than 140 mV

C: Voltage drop ΔV of 140 mV to less than 160 mV

D: Voltage drop ΔV of 160 mV to less than 180 mV

E: Voltage drop ΔV of 180 mV or more

### Production Example 1

### Production of Particulate-Shaped Saturated Nitrile Polymer (A1)

To an autoclave equipped with a stirrer, ion exchanged water 240 parts, sodium alkylbenzenesulfonate 2.5 parts, acrylonitrile 35 parts, and methacrylic acid 5 parts were added into that order. The inside of the bottle was replaced with nitrogen, then butadiene 60 parts was charged under pressure, ammonium persulfate 0.25 part was added, and a polymerization reaction was caused at a reaction temperature of 40° C. to obtain an aqueous dispersion of nitrile polymer. The polymerization conversion rate was 85%, and the iodine value of the nitrile polymer was 280.

Next, the above obtained aqueous dispersion of nitrile polymer was adjusted to a total solid content concentration of 12 wt %. The aqueous dispersion of nitrile polymer which was adjusted in solid content concentration was charged in an amount of 400 ml (48 g in total solid content) into a 1-liter autoclave equipped with a stirrer, nitrogen gas was run for 10 minutes to remove the solute oxygen in the nitrile polymer, then a hydrogenation catalyst constituted by palladium acetate 75 mg was dissolved in water 180 ml to which 4 molar fold of nitric acid with respect to the Pd was added was introduced. Further, the inside of the system was replaced with hydrogen gas two times, then the content of the autoclave was warmed to 50° C. in a state pressurized to 3 MPa by hydrogen gas and was subjected to a hydrogenation reaction for 6 hours (referred to as “first stage hydrogenation reaction”). At this time, the iodine value of the nitrile polymer was 35.

Next, the autoclave was returned to atmospheric pressure, then a hydrogenation catalyst constituted by palladium acetate 25 mg was dissolved in water 60 ml to which 4 molar fold of nitric acid with respect to the Pd was added was introduced. Further, the inside of the system was replaced with hydrogen gas two times, then the content of the autoclave was warmed to 50° C. in a state pressurized to 3 MPa by hydrogen gas and was subjected to a hydrogenation reaction for 6 hours (referred to as “second stage hydrogenation reaction”).

After that, the content was returned to ordinary temperature, the inside of the system was made a nitrogen atmosphere, then an evaporator was used to concentrate the solution to a solid content concentration of 40% to thereby obtain an aqueous dispersion of the particle-shaped saturated nitrile polymer (A1). Note that, the iodine value of the obtained particle-shaped saturated nitrile polymer (A1) was 7 mg/100 mg and the average particle size was 117 nm. Further, the aqueous dispersion of the particle-shaped binder 100 g was coagulated by 1 liter of methanol and dried in vacuo at 60° C. for 12 hours to obtain a dried polymer. The composition of the obtained dried polymer was analyzed by NMR, whereupon the composition of the particle-shaped saturated nitrile polymer (A1) was acrylonitrile units: 35%, butadiene units and saturated butadiene units: 60%, and methacrylic acid units: 5%.

### Production Example 2

### Production of Particulate-Shaped Saturated Nitrile Polymer (A2)

Except for changing the amount of the acrylonitrile from 35 parts to 25 parts and the amount of butadiene from 60 parts to 70 parts, the same procedure was followed as in Production Example 1 to obtain an aqueous dispersion of a particle-shaped saturated nitrile polymer (A2). The iodine value of the obtained particle-shaped saturated nitrile polymer (A2) was 7 mg/100 mg and the average particle size was 123 nm. The composition of the particle-shaped saturated nitrile polymer (A2) was acrylonitrile units: 25%, butadiene units and saturated butadiene units: 70%, and methacrylic acid units: 5%.

### Production Example 3

### Production of Particulate-Shaped Saturated Nitrile Polymer (A3)

Except for changing the amount of the acrylonitrile from 35 parts to 15 parts and the amount of butadiene from 60 parts to 80 parts, the same procedure was followed as in Production Example 1 to obtain an aqueous dispersion of a particle-shaped saturated nitrile polymer (A3). The iodine value of the obtained particle-shaped saturated nitrile polymer (A3) was 7 mg/100 mg and the average particle size was 110 nm. The composition of the particle-shaped saturated nitrile polymer (A3) was acrylonitrile units: 15%, butadiene units and saturated butadiene units: 80%, and methacrylic acid units: 5%.

### Production Example 4

### Production of Particulate-Shaped Saturated Nitrile Polymer (A4)

Except for changing the amount of use of palladium acetate in the first stage hydrogenation reaction from 75 mg to 90 mg and changing the amount of use of palladium acetate in the second stage hydrogenation reaction from 25 mg to 10 mg, the same procedure was followed as in Production Example 1 to obtain an aqueous dispersion of a particle-shaped saturated nitrile polymer (A4). The iodine value of the obtained particle-shaped saturated nitrile polymer (A4) was 15 mg/100 mg and the average particle size was 120 nm. The composition of the particle-shaped saturated nitrile polymer (A4) was acrylonitrile units: 35%, butadiene units and saturated butadiene units: 60%, and methacrylic acid units: 5%.

### Production Example 5

### Production of Particulate-Shaped Saturated Nitrile Polymer (A5)

Except for changing the amount of use of palladium acetate in the first stage hydrogenation reaction from 75 mg to 10 mg and not performing the second stage hydrogenation reaction, the same procedure was followed as in Production Example 1 to obtain an aqueous dispersion of a particle-shaped saturated nitrile polymer (A5). The iodine value of the obtained particle-shaped saturated nitrile polymer (A5) was 27 mg/100 mg and the average particle size was 114 nm. The composition of the particle-shaped saturated nitrile polymer (A5) was acrylonitrile units: 35%, butadiene units and saturated butadiene units: 60%, and methacrylic acid units: 5%.

### Production Example 6

### Production of Particulate-Shaped Saturated Nitrile Polymer (A6)

Except for using, instead of methacrylic acid 5 parts, maleic acid 5 parts, the same procedure was followed as in Production Example 1 to obtain an aqueous dispersion of a particle-shaped saturated nitrile polymer (A6). The iodine value of the obtained particle-shaped saturated nitrile polymer (A6) was 7 mg/100 mg and the average particle size was 120 nm. The composition of the particle-shaped saturated nitrile polymer (A6) was acrylonitrile units: 35%, butadiene units and saturated butadiene units: 60%, maleic acid units: 5%.

### Production Example 7

### Production of Particulate-Shaped Saturated Nitrile Polymer (A7)

Except for using, instead of methacrylic acid 5 parts, acrylamide-2-methyl propanesulfonic acid (AMPS) 5 parts, the same procedure was followed as in Production Example 1 to obtain an aqueous dispersion of a particle-shaped saturated nitrile polymer (A7). The iodine value of the obtained particle-shaped saturated nitrile polymer (A7) was 7 mg/100 mg and the average particle size was 122 nm. The composition of the particle-shaped saturated nitrile polymer (A7) was acrylonitrile units: 35%, butadiene units and saturated butadiene units: 60%, acrylamide-2-methyl propanesulfonic acid units: 5%.

### Production Example 8

### Production of Particulate-Shaped Saturated Nitrile Polymer (A8)

Except for using, instead of methacrylic acid 5 parts, 2-methacryloyloxyethyl phosphate 5 parts, the same procedure was followed as in Production Example 1 to obtain an aqueous dispersion of a particle-shaped saturated nitrile polymer (A8). The iodine value of the obtained particle-shaped saturated nitrile polymer (A8) was 7 mg/100 mg and the average particle size was 125 nm. The composition of the particle-shaped saturated nitrile polymer (A8) was acrylonitrile units: 35%, butadiene units and saturated butadiene units: 60%, and 2-methacryloyloxyethyl phosphate units: 5%.

### Production Example 9

### Production of Particulate-Shaped Saturated Nitrile Polymer (A9)

Except for changing the amount of the acrylonitrile from 35 parts to 55 parts and the amount of butadiene from 60 parts to 40 parts, the same procedure was followed as in Production Example 1 to obtain an aqueous dispersion of a particle-shaped saturated nitrile polymer (A9). The iodine value of the obtained particle-shaped saturated nitrile polymer (A9) was 7 mg/100 mg and the average particle size was 128 nm. The composition of the particle-shaped saturated nitrile polymer (A9) was acrylonitrile units: 55%, butadiene units and saturated butadiene units: 40%, and methacrylic acid units: 5%.

### Production Example 10

### Production of Particulate-Shaped Saturated Nitrile Polymer (A10)

Except for changing the amount of the acrylonitrile from 35 parts to 2 parts and the amount of butadiene from 60 parts to 93 parts, the same procedure was followed as in Production Example 1 to obtain an aqueous dispersion of a particle-shaped saturated nitrile polymer (A10). The iodine value of the obtained particle-shaped saturated nitrile polymer (A10) was 7 mg/100 mg and the average particle size was 115 nm. The composition of the particle-shaped saturated nitrile polymer (A10) was acrylonitrile units: 2%, butadiene units and saturated butadiene units: 93%, and methacrylic acid units: 5%.

### Production Example 11

### Production of Particulate-Shaped Saturated Nitrile Polymer (A11)

Except for changing the amount of use of palladium acetate in the first stage hydrogenation reaction from 75 mg to 53 mg and not performing the second stage hydrogenation reaction, the same procedure was followed as in Production Example 1 to obtain an aqueous dispersion of a particle-shaped saturated nitrile polymer (A11). The iodine value of the obtained particle-shaped saturated nitrile polymer (A11) was 50 mg/100 mg and the average particle size was 120 nm. The composition of the particle-shaped saturated nitrile polymer (A11) was acrylonitrile units: 35%, butadiene units and saturated butadiene units: 60%, and methacrylic acid units: 5%.

### Production Example 12

### Production of Particulate-Shaped Saturated Nitrile Polymer (A12)

Except for changing the amount of use of palladium acetate in the second stage hydrogenation reaction from 25 mg to 75 mg, the same procedure was followed as in Production Example 1 to obtain an aqueous dispersion of a particle-shaped saturated nitrile polymer (A12). The iodine value of the obtained particle-shaped saturated nitrile polymer (A12) was 1 mg/100 mg and the average particle size was 119 nm. The composition of the particle-shaped saturated nitrile polymer (A12) was acrylonitrile units: 35%, butadiene units and saturated butadiene units: 60%, and methacrylic acid units: 5%.

### Production Example 13

### Production of Particulate-Shaped Saturated Nitrile polymer (A13)

Except for changing the amount of butadiene from 60 parts to 65 parts and not using methacrylic acid, the same procedure was followed as in Production Example 1 to obtain an aqueous dispersion of a particle-shaped saturated nitrile polymer (A13). The iodine value of the obtained particle-shaped saturated nitrile polymer (A13) was 7 mg/100 mg and the average particle size was 120 nm. The composition of the particle-shaped saturated nitrile polymer (A13) was acrylonitrile units: 35% and butadiene units and saturated butadiene units: 65%.

### Production Example 14

### Production of Saturated Nitrile Polymer (A14)

To an autoclave equipped with a stirrer, ion exchanged water 240 parts, sodium alkylbenzenesulfonate 2.5 parts, acrylonitrile 35 parts, and methacrylic acid 5 parts were added in that order. The inside of the bottle was replaced with nitrogen, then butadiene 60 parts was charged under pressure, ammonium persulfate 0.25 part was added, and a polymerization reaction was caused at a reaction temperature of 40° C. to obtain an aqueous dispersion of nitrile polymer. The polymerization conversion rate was 85%, and the iodine value of the nitrile polymer was 280.

Next, the above obtained aqueous dispersion of nitrile polymer was added to an amount of aqueous solution of magnesium sulfate to give 12 parts by weight of the dispersion when making the amount of nitrile polymer in the aqueous dispersion 100 parts by weight. The mixture was stirred to cause the aqueous dispersion to coagulate, then the result was washed by water while filtering, then was dried in vacuo at 60° C. for 12 hours to obtain a nitrile polymer.

Next, the above obtained nitrile polymer was dissolved in acetone to a concentration of 12 wt %. This was placed in an autoclave, then an amount of palladium-silica catalyst giving an amount of Pd metal of 1000 wt ppm with respect to the amount of nitrile polymer was added and a hydrogenation reaction performed at 3.0 MPa. After the end of the hydrogenation reaction, the result was poured into a large amount of water to cause it to coagulate. The result was filtered and dried to obtain a saturated nitrile polymer (A14). Note that, the obtained saturated nitrile polymer (A14) was dissolved in acetone and did not have a particle shape. Further, the iodine value of the saturated nitrile polymer (A14) was 7 mg/100 mg, and the composition of the saturated nitrile polymer (A14) was acrylonitrile units: 35%, butadiene units and saturated butadiene units: 60%, and methacrylic acid units: 5%.

Further, the obtained saturated nitrile polymer (A14) was dissolved in N-methylpyrrolidone (NMP) to obtain an N-methylpyrrolidone solution of saturated nitrile polymer (A14) (solid content concentration 8%).

### Production Example 15

### Production of Particulate-Shaped Saturated Nitrile Polymer (A15)

Except for changing the amount of acrylonitrile from 35 parts to 20 parts and the amount of butadiene from 60 parts to 75 parts, the same procedure was followed as in Production Example 1 to obtain an aqueous dispersion of a particle-shaped saturated nitrile polymer (A15). The iodine value of the obtained particle-shaped saturated nitrile polymer (A15) was 7 mg/100 mg and the average particle size was 120 nm. The composition of the particle-shaped saturated nitrile polymer (A15) was acrylonitrile units: 20%, butadiene units and saturated butadiene units: 75%, and methacrylic acid units: 5%.

### Production Example 16

### Production of Particulate-Shaped Saturated Nitrile Polymer (A16)

Except for changing the amount of acrylonitrile from 35 parts to 30 parts and the amount of butadiene from 60 parts to 65 parts, the same procedure was followed as in Production Example 1 to obtain an aqueous dispersion of a particle-shaped saturated nitrile polymer (A16). The iodine value of the obtained particle-shaped saturated nitrile polymer (A16) was 7 mg/100 mg and the average particle size was 117 nm. The composition of the particle-shaped saturated nitrile polymer (A16) was acrylonitrile units: 30%, butadiene units and saturated butadiene units: 65%, and methacrylic acid units 5%.

### Production Example 17

### Production of Particulate-Shaped Saturated Nitrile Polymer (A17)

Except for changing the amount of palladium acetate in the second stage hydrogenation reaction from 25 mg to 75 mg, the same procedure was followed as in Production Example 2 to obtain an aqueous dispersion of a particle-shaped saturated nitrile polymer (A17). The iodine value of the obtained particle-shaped saturated nitrile polymer (A17) was 4 mg/100 mg and the average particle size was 119 nm. The composition of the particle-shaped saturated nitrile polymer (A17) was acrylonitrile units: 25%, butadiene units and saturated butadiene units: 70%, and methacrylic acid units: 5%.

### Production Example 18

### Production of Particulate-Shaped Saturated Nitrile Polymer (A18)

Except for changing the amount of use of palladium acetate in the first stage hydrogenation reaction from 75 mg to 90 mg and changing the amount of use of palladium acetate in the second stage hydrogenation reaction from 25 mg to 10 mg, the same procedure was followed as in Production Example 2 to obtain an aqueous dispersion of a particle-shaped saturated nitrile polymer (A18). The iodine value of the obtained particle-shaped saturated nitrile polymer (A18) was 9 mg/100 mg and the average particle size was 120 nm. The composition of the particle-shaped saturated nitrile polymer (A18) was acrylonitrile units: 25%, butadiene units and saturated butadiene units: 70%, methacrylic acid units: 5%.

### Production Example 19

### Production of Particulate-Shaped Saturated Nitrile Polymer (A19)

Except for using, instead of methacrylic acid 5 parts, acrylamide-2-methyl propanesulfonic acid (AMPS) 5 parts, the same procedure was followed as in Production Example 2 to obtain an aqueous dispersion of a particle-shaped saturated nitrile polymer (A19). The iodine value of the obtained particle-shaped saturated nitrile polymer (A19) was 7 mg/100 mg and the average particle size was 119 nm. The composition of the particle-shaped saturated nitrile polymer (A19) was acrylonitrile units: 25%, butadiene units and saturated butadiene units: 70%, and acrylamide-2-methyl propanesulfonic acid units (AMPS units): 5%.

### Production Example 20

### Production of Particulate-Shaped Acrylic Polymer (B1)

To a polymerization vessel A, ion exchanged water 130 parts was added. To this, a polymerization initiator constituted by ammonium persulfate 0.8 part and ion exchanged water 10 parts were added and warmed to 80° C. Further, to a polymerization vessel B separate from this, 2-ethylhexyl acrylate 83 parts, acrylonitrile 15 parts, methacrylic acid 2 parts, an emulsifier constituted by end hydrophobic group polyvinyl alcohol (product name “MP102”, made by Kuraray, nonionic surfactant) 10 parts, and ion exchanged water 377 parts were added and stirred to prepare an emulsion. Further, the emulsion which was prepared in the polymerization vessel B was gradually added to the polymerization vessel A over about 240 minutes, then was stirred for about 30 minutes. The solution was cooled when the amount of consumption of the monomer reached 95% to end the reaction and thereby obtain an aqueous dispersion of the particle-shaped acrylic polymer (B1). The obtained particle-shaped acrylic polymer (B1) had a glass transition temperature of −30° C. and had an average particle size of 150 nm. The composition was measured by ¹H-NMR, whereby it was 2-ethylhexyl acrylate units: 83%, acrylonitrile units: 15%, and methacrylic acid units: 2%.

### Production Example 21

### Production of Particulate-Shaped Acrylic Polymer (B2)

Except for changing the amount of the 2-ethylhexyl acrylate from 83 parts to 78 parts and the amount of acrylonitrile from 15 parts to 20 parts, the same procedure was followed as in Production Example 20 to obtain an aqueous dispersion of a particle-shaped acrylic polymer (B2). The obtained particle-shaped acrylic polymer (B2) had a glass transition temperature of −20° C. and had an average particle size of 150 nm. The composition of the particle-shaped acrylic polymer (B2) was 2-ethylhexyl acrylate units: 78%, acrylonitrile units: 20%, and methacrylic acid units: 2%.

### Production Example 22

### Production of Particulate-Shaped Acrylic Polymer (B3)

Except for changing the amount of the 2-ethylhexyl acrylate from 83 parts to 98 parts and not using acrylonitrile, the same procedure was followed as in Production Example 20 to obtain an aqueous dispersion of a particle-shaped acrylic polymer (B3). The obtained particle-shaped acrylic polymer (B3) had a glass transition temperature of −60° C. and had an average particle size of 160 nm. The composition of the particle-shaped acrylic polymer (B3) was 2-ethylhexyl acrylate units: 98% and methacrylic acid units: 2%.

### Production Example 23

### Production of Particulate-Shaped Acrylic Polymer (B4)

Except for changing the amount of 2-ethylhexyl acrylate from 83 parts to 85 parts and not using methacrylic acid, the same procedure was followed as in Production Example 20 to obtain an aqueous dispersion of a particle-shaped acrylic polymer (B4). The obtained particle-shaped acrylic polymer (B4) had a glass transition temperature of −35° C. and had an average particle size of 152 nm. The composition of the particle-shaped acrylic polymer (B4) was 2-ethylhexyl acrylate units: 85% and acrylonitrile units: 15%.

### Production Example 24

### Antioxidant (C1)

In accordance with the following method, the antioxidant (C1) which is shown in the following formula (4) was synthesized.

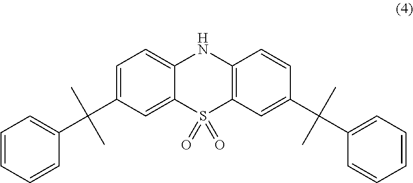 [SMILES: CC(C)(c1ccccc1)c1ccc2c(c1)S(=O)(=O)c1cc(C(C)(C)c3ccccc3)ccc1N2]

That is, first, in a three-necked reactor provided with a thermometer, phenothiazine 50.0 g (250.92 mmol) was added in a nitrogen gas stream and dissolved in toluene 200 ml. Next, to this solution, α-methylstyrene 59.31 g (501.83 mmol) and β-toluene sulfonic acid 1-hydrate 1.19 g (6.27 mmol) were added and reacted at 80° C. for 1 hour. After this, the reaction solution was returned to room temperature and acetate acid 48 ml and 30% hydrogen peroxide 85.34 g (752.7 mmol) were added and further reacted at 80° C. for 2 hours. The reaction solution was returned to room temperature, then was charged into methanol 630 ml. Further, the precipitated crystal was filtered and washed by 320 ml of methanol to obtain a white crystal antioxidant (C1) in 85.7 g for a yield of 73%. The structure of the obtained antioxidant (C1) was identified by ¹H-NMR. ¹H-NMR (500 MHz, DMSO-d6, TMS, δppm): 1.67 (s, 12H), 7.15-7.32 (m, 12H), 7.43 (dd, 2H, J=9.0, 2.0 Hz), 7.68 (d, 2H, J=1.5 Hz), 10.84 (s, 1H).

### Production Example 25

### Production of Antioxidant (C2)

The following method was followed to synthesize the antioxidant (C2) which is shown in the following formula (5). Note that, when synthesizing the antioxidant (C2), first, the intermediate A which is shown by the following formula (6) was obtained and the obtained intermediate A was used for synthesis.

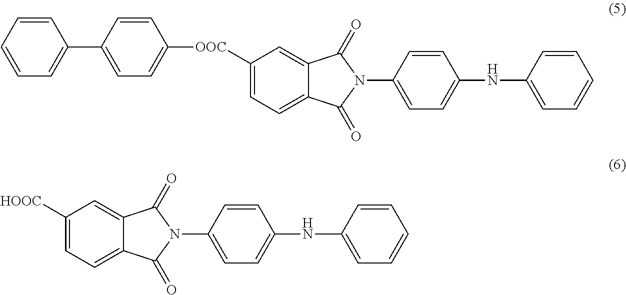

First, the following method was used to produce the intermediate A. That is, in a four-necked reactor provided with a cooler and thermometer, trimellitic acid anhydride 80 g (0.42 mol) and 4-aminodiphenylamine 76.7 g (0.42 mol) were dissolved in 1 liter of acetic acid in a nitrogen gas stream. This solution was reacted in an oil bath for 10 hours while heating and refluxing it. After the end of the reaction, the reaction solution was charged into 2 liters of water to make the solid precipitate. After that, the precipitated solid was suction filtered. Further, the obtained filtrate was successively washed with water and methanol, then was dried by a vacuum drier to obtain a greenish yellow colored solid intermediate A in 138.5 g (yield: 92%). The structure of the obtained intermediate A was identified by ¹H-NMR. ¹H-NMR (500 MHz, THF-d8, TMS, δppm): 6.97 (t, 1H, J=7.0 Hz), 7.24-7.28 (m, 4H), 7.33-7.36 (m, 2H), 7.40-7.42 (m, 2H), 7.68 (s, 1H), 8.11 (d, 1H, J=8.5 Hz), 8.56-8.58 (m, 2H), 12.20 (bs, 1H).

Next, the obtained intermediate A was used in accordance with the following method to obtain an antioxidant (C2). That is, in a four-necked reactor provided with a cooler, thermometer, and dropping funnel, the above obtained intermediate A, 10 g (0.028 mol), 4-hydroxybiphenyl 5.7 g (0.033 mol) and N,N-dimethyl-4-aminopyridine 400 mg (0.0033 mol) were dissolved in N-methylpyrrolidone 150 ml in a nitrogen gas stream. To this solution, 1-ethyl-3-(3-dimethylaminopropyl)carbodiimide hydrochloride (WSC) 6.4 g (0.033 mol) was added at room temperature. After this, the reaction was performed at room temperature for 14 hours. After the end of the reaction, the reaction solution was charged into water, the solid was precipitated, and the precipitated solid was suction filtered. Further, the obtained solid was dissolved again in N-methylpyrrolidone 100 ml and was gradually charged into 1 liter of methanol to make the solid precipitate. The precipitated solid was suction filtered and the filtrate was washed with methanol. Furthermore, again, the obtained solid was dissolved in N-methylpyrrolidone 100 ml and was gradually charged into 1 liter of methanol to make the solid precipitate. The precipitated solid was suction filtered and the filtrate was washed with methanol. Further, the obtained filtrate was dried in a vacuum drier to obtain a yellow solid antioxidant (C2) in 12.1 g (yield: 85%). The structure of the obtained antioxidant (C2) was identified by ¹H-NMR. ¹H-NMR (500 MHz, DMF-d7, TMS, δppm): 6.92 (t, 1H, J=7.5 Hz), 7.25 (d, 2H, J=7.5 Hz), 7.29-7.33 (m, 4H), 7.41-7.44 (m, 3H), 7.52 (t, 2H, J=8.0 Hz), 7.57 (d, 2H, J=9.0 Hz), 7.77 (dd, 2H, J=1.0 Hz, 8.5 Hz), 7.87 (d, 2H, J=11.5 Hz), 8.22 (d, 1H, J=13.5 Hz), 8.49 (s, 1H), 8.58-8.59 (m, 1H), 8.71 (dd, 1H, J=1.5 Hz, 7.5 Hz).

### Example 1-1

### Production of Slurry for Composite Particle for Positive Electrode

A positive electrode active material constituted by LiNiO₂, 100 parts, an conductive material constituted by acetylene black (HS-100, made by Denki Kagaku Kogyo) 2 parts, a binder constituted by an aqueous dispersion of the particle-shaped saturated nitrile polymer (A1) which was obtained in Production Example 1, 2.5 parts converted to solid content, and a thickener constituted by an aqueous solution of carboxymethylcellulose with a degree of etherification of 0.8, 2 parts converted to solid content were mixed, ion exchanged water was added in a suitable quantity, and the result was mixed and dispersed by a planetary mixer to prepare a slurry for composite particle for positive electrode with a solid content concentration of 20%.

Production of Composite Particles for Positive Electrode

The above obtained slurry for composite particle for positive electrode was spray dried for granulation using a spray drier (Ohkawara Kakohki) and using a rotary disk type atomizer (diameter 65 mm) under conditions of a speed of 25,000 rpm, a hot air temperature of 150° C., and a temperature at the particle recovery outlet of 90° C. to obtain composite particles for positive electrode. The obtained composite particles had an average volume particle size of 40 μm.

Production of Positive Electrode

The above obtained composite particles for positive electrode were supplied on a roll of a roll press (rough surface hot roll, made by Hirano Gikenkogyo) (roll temperature 100° C., press linear pressure 4.0 kN/cm) together with a current collector constituted by aluminum foil and were formed into a sheet shape by a shaping speed of 20 m/min on a current collector constituted by aluminum foil to obtain a positive electrode which has a thickness 80 μm positive electrode active material layer.

Production of Slurry for Composite Particle for Negative Electrode

A negative electrode active material constituted by artificial graphite (average particle size: 24.5 μm) 100 parts, a binder constituted by an aqueous dispersion of the particle-shaped saturated nitrile polymer (A1) which was obtained in Production Example 1, 2.7 parts converted to solid content, and a thickener constituted by an aqueous solution of carboxymethylcellulose with a degree of etherification of 0.8, 0.7 part converted to solid content were mixed, ion exchanged water was added in a suitable quantity, and the result was mixed and dispersed by a planetary mixer to prepare a slurry for composite particle for negative electrode with a solid content concentration of 20%.

Production of Composite Particles for Negative Electrode

The above obtained slurry for composite particle for negative electrode was spray dried for granulation using a spray drier (Ohkawara Kakohki) and using a rotary disk type atomizer (diameter 65 mm) under conditions of a speed of 25,000 rpm, a hot air temperature of 150° C., and a temperature at the particle recovery outlet of 90° C. to obtain composite particles for negative electrode. The obtained composite particles had an average volume particle size of 40 μm.

Production of Negative Electrode

The above obtained composite particles for negative electrode were supplied on a roll of a roll press (rough surface hot roll, made by Hirano Gikenkogyo) (roll temperature 100° C., press linear pressure 4.0 kN/cm) together with a current collector constituted by copper foil and were formed into a sheet shape by a shaping speed of 20 m/min on a current collector constituted by copper foil to obtain a negative electrode which has a thickness 80 μm negative electrode active material layer.

Production of Lithium Ion Secondary Cell

The above obtained positive electrode was punched out to a diameter 13 mm disk shape and, further, the above obtained negative electrode was punched out to a diameter 14 mm disk shape. Further, on the 13 mm disk-shaped positive electrode, a diameter 18 mm, thickness 25 μm disk-shaped separator comprised of a polypropylene porous film and the 14 mm disk-shaped negative electrode were laminated in that order. This assembly was placed in a stainless steel coin-shaped outside container (diameter 20 mm, height 1.8 mm, stainless steel thickness 0.25 mm) in which a polypropylene packing was set. Next, this container was filled with an electrolytic solution (solvent: ethylene carbonate/diethyl carbonate=1/2 (volume ratio at 20° C.), electrolyte: 1M LiPF₆) so as not to leave any air, a thickness 0.2 mm stainless steel cap was placed and fastened on the outer container via the polypropylene packing, and the cell can was sealed to produce a diameter 20 mm, thickness about 2 mm coin-type lithium ion secondary cell (coin cell CR2032).

Further, the above obtained positive electrode was used to evaluate the peel strength and shapeability, while the lithium ion secondary cell was used to evaluate the internal resistance and high temperature cycle characteristics. The results are shown in Table 1.

### Examples 1-2 to 1-8

Except for using as the binder which is used at the time of production of the composite particles for positive electrode and composite particles for negative electrode, instead of the aqueous dispersion of the particle-shaped saturated nitrile polymer (A1) which was obtained in Production Example 1, aqueous dispersions of the particle-shaped saturated nitrile polymers (A2) to (A8) which were obtained in Production Example 2 to 8, the same procedure was followed as in Example 1-1 to produce positive electrodes, negative electrodes, and lithium ion secondary cells and similarly evaluate them. The results are shown in Table 1.

### Comparative Examples 1-1 to 1-5

Except for using as the binder which is used at the time of production of the composite particles for positive electrode and composite particles for negative electrode, instead of the aqueous dispersion of the particle-shaped saturated nitrile polymer (A1) which was obtained in Production Example 1, aqueous dispersions of the particle-shaped saturated nitrile polymers (A9) to (A13) which were obtained in Production Examples 9 to 13, the same procedure was followed as in Example 1-1 to produce positive electrodes, negative electrodes, and lithium ion secondary cells and similarly evaluate them. The results are shown in Table 2.

### Comparative Example 1-6

Except for using as the binder which is used at the time of production of the composite particles for positive electrode and composite particles for negative electrode, instead of the aqueous dispersion of the particle-shaped saturated nitrile polymer (A1) which was obtained in Production Example 1, an N-methylpyrrolidone solution of the saturated nitrile polymer (A14) which was obtained in Production Example 14, the same procedure was followed as in Example 1-1 to produce a positive electrode, negative electrode, and lithium ion secondary cell and similarly evaluate them. Note that, the amount of the N-methylpyrrolidone solution of the saturated nitrile polymer (A14) was made 1 part converted to solid content. The results are shown in Table 2.

### Comparative Example 1-7

The same procedure was followed as in Example 1-1 to prepare a slurry for composite particle for positive electrode. The obtained slurry for composite particle for positive electrode was coated by a comma coater on a current collector constituted by aluminum foil and was heat treated at 150° C. for 2 hours to obtain an electrode material. Further, this electrode material was rolled by a roll press to prepare a positive electrode with a positive electrode active material layer of a thickness of 80 μm.

Further, separate from the above, the same procedure was followed as in Example 1-1 to prepare a slurry for composite particle for negative electrode. The obtained slurry for composite particle for negative electrode was coated by a comma coater on a current collector constituted by copper foil and heat treated at 150° C. for 2 hours to obtain an electrode material. Further, this electrode material was rolled by a roll press to prepare a negative electrode with a negative electrode active material layer of a thickness of 80 μm.

Further, except for using the above obtained positive electrode and negative electrode, the same procedure was followed as in Example 1-1 to produce a lithium ion secondary cell and similarly evaluate it. The results are shown in Table 2.

### Comparative Example 1-8

To 100 parts of an aqueous dispersion of the particle-shaped saturated nitrile polymer (A1) which was obtained in Production Example 1, N-methylpyrrolidone 320 parts was added. Next, the water was evaporated off under reduced pressure to obtain an N-methylpyrrolidone solution of a particle-shaped saturated nitrile polymer (A1). Note that, the particle-shaped saturated nitrile polymer (A1) was one which did not have a particle shape in the N-methylpyrrolidone solution.

Further, except for using instead of the N-methylpyrrolidone solution of the saturated nitrile polymer (A14) which was obtained in Production Example 14, the above obtained N-methylpyrrolidone solution of the particle-shaped saturated nitrile polymer (A1), the same procedure was followed as in Comparative Example 1-7 to obtain a slurry for composite particle for positive electrode and a slurry for composite particle for negative electrode.

Further, using the above obtained slurry for composite particle for positive electrode and slurry for composite particle for negative electrode, the same procedure was followed as in Comparative Example 1-7 to produce a positive electrode and negative electrode. The produced positive electrode and negative electrode were used to produce a lithium ion secondary cell and similarly evaluate it. The results are shown in Table 2.

TABLE 1

| Example | | | | | | | |
|---|---|---|---|---|---|---|---|
| I-1 | I-2 | I-3 | I-4 | I-5 | I-6 | I-7 | I-8 |

Binder for positive electrode and negative electrode

| Type | | A1 | A2 | A3 | A4 | A5 | A6 | A7 | A8 |
|---|---|---|---|---|---|---|---|---|---|
| Composition | Acrylonitrile units (%) | 35 | 25 | 15 | 35 | 35 | 35 | 35 | 35 |
| | Butadiene units and | 60 | 70 | 80 | 60 | 60 | 60 | 60 | 60 |
| | saturated butadiene units (%) | | | | | | | | |
| | Methacrylic acid units (%) | 5 | 5 | 5 | 5 | 5 | — | — | — |
| | Maleic acid units (%) | — | — | — | — | — | 5 | — | — |
| | Acrylamide-2-methylpropane | — | — | — | — | — | — | 5 | — |
| | sulfonic acid units (%) | | | | | | | | |
| | Phosphoric acid-2-methacryl- | — | — | — | — | — | — | — | 5 |
| | oyloxyethyl units (%) | | | | | | | | |
| Hydrogenation | Amount of addition of palladium | 75 | 75 | 75 | 90 | 100 | 75 | 75 | 75 |
| conditions | acetate (1st stage) (mg) | | | | | | | | |
| | Amount of addition of palladium | 25 | 25 | 25 | 10 | — | 25 | 25 | 25 |
| | acetate (2nd stage) (mg) | | | | | | | | |
| | Solvent used for hydrogenation | Water | Water | Water | Water | Water | Water | Water | Water |
| | reaction (mg) | | | | | | | | |

| | | | | | | | | |
|---|---|---|---|---|---|---|---|---|
| Iodine value (mg/100 mg) | 7 | 7 | 7 | 15 | 27 | 7 | 7 | 7 |
| Shape | Particles | Particles | Particles | Particles | Particles | Particles | Particles | Particles |
| Average particle size (nm) | 117 | 123 | 110 | 120 | 114 | 120 | 122 | 125 |
| Form of addition of binder | Aqueous | Aqueous | Aqueous | Aqueous | Aqueous | Aqueous | Aqueous | Aqueous |
| | dispersion | dispersion | dispersion | dispersion | dispersion | dispersion | dispersion | dispersion |
| Method of formation of positive electrode | Powder | Powder | Powder | Powder | Powder | Powder | Powder | Powder |
| and negative electrode | forming | forming | forming | forming | forming | forming | forming | forming |

Evaluation

| | | | | | | | | |
|---|---|---|---|---|---|---|---|---|
| Peel strength | A | B | B | A | A | A | A | A |
| Shapeability | A | A | B | A | A | A | B | B |
| Internal resistance | A | B | B | A | B | A | B | B |
| High temperature cycle characteristics | A | A | B | B | B | A | B | B |

TABLE 2

| Comparative Example | | | | | | | |
|---|---|---|---|---|---|---|---|
| I-1 | I-2 | I-3 | I-4 | I-5 | I-6 | I-7 | I-8 |

Binder for positive electrode and negative electrode

| Type | | A9 | A10 | A11 | A12 | A13 | A14 | A1 | A1 |
|---|---|---|---|---|---|---|---|---|---|
| Composition | Acrylonitrile units (%) | 55 | 2 | 35 | 35 | 35 | 35 | 35 | 35 |
| | Butadiene units and | 40 | 93 | 60 | 60 | 65 | 60 | 60 | 60 |
| | saturated butadiene units (%) | | | | | | | | |
| | Methacrylic acid units (%) | 5 | 5 | 5 | 5 | — | 5 | 5 | 5 |
| | Maleic acid units (%) | — | — | — | — | — | — | — | — |
| | Acrylamide-2-methylpropane | — | — | — | — | — | — | — | — |
| | sulfonic acid units (%) | | | | | | | | |
| | Phosphoric acid-2-methacryl- | — | — | — | — | — | — | — | — |
| | oyloxyethyl units (%) | | | | | | | | |
| Hydrogenation | Amount of addition of palladium | 75 | 75 | 53 | 75 | 75 | 75 | 75 | 75 |
| conditions | acetate (1st stage) (mg) | | | | | | | | |
| | Amount of addition of palladium | 25 | 25 | — | 75 | 25 | 25 | 25 | 25 |
| | acetate (2nd stage) (mg) | | | | | | | | |
| | Solvent used for hydrogenation | Water | Water | Water | Water | Water | Acetone | Water | Water |
| | reaction (mg) | | | | | | | | |

| | | | | | | | | |
|---|---|---|---|---|---|---|---|---|
| Iodine value (mg/100 mg) | 7 | 7 | 50 | 1 | 7 | 7 | 7 | 7 |
| Shape | Particles | Particles | Particles | Particles | Particles | Non-particles | Particles | Particles |
| Average particle size (nm) | 128 | 115 | 120 | 119 | 120 | — | 117 | — |
| Form of addition of binder | Aqueous | Aqueous | Aqueous | Aqueous | Aqueous | NMP | Aqueous | NMP |
| | dispersion | dispersion | dispersion | dispersion | dispersion | solution | dispersion | solution |
| Method of formation of positive electrode | Powder | Powder | Powder | Powder | Powder | Powder | Powder | Powder |
| and negative electrode | forming | forming | forming | forming | forming | forming | forming | forming |

Evaluation

| | | | | | | | | |
|---|---|---|---|---|---|---|---|---|
| Peel strength | B | C | A | D | D | D | C | A |
| Shapeability | D | C | A | D | A | D | D | A |
| Internal resistance | E | D | C | D | C | D | E | D |
| High temperature cycle characteristics | E | D | D | E | D | E | E | C |

### (Evaluation of Examples 1-1 to 1-8 and Comparative Examples 1-1 to 1-8

As shown in Table 1, when using the predetermined particle-shaped binders of the present invention, the obtained electrodes were excellent in peel strength and shapeability and, further, were low in internal resistance and excellent in high temperature cycle characteristics when made into cells (Examples 1-1 to 1-8).

On the other hand, when using as the particle-shaped binder one which has too much acrylonitrile units, the shapeability when made into an electrode fell and the internal resistance and high temperature cycle characteristics when made into a cell fell (Comparative Example 1-1).

Further, when using as the particle-shaped binder one which has too little acrylonitrile units or when using one which has too low an iodine value, the peel strength and shapeability when made into an electrode fell and, further, the internal resistance and high temperature cycle characteristics when made into a cell fell (Comparative Examples 1-2 and 1-4).

Furthermore, when using as the particle-shaped binder one which has too high an iodine value, the internal resistance and high temperature cycle characteristics when made into a cell fell (Comparative Example 1-3).

Alternatively, when using as the particle-shaped binder one which does not contain a monomer unit which has an acidic functional group, the peel strength when made into an electrode fell and, further, the internal resistance and high temperature cycle characteristics when made into a cell fell (Comparative Example 1-5).

Furthermore, when performing the hydrogenation reaction at the time of production of the binder in acetone and therefore using a binder which does not have a particle shape or when using coating to form the electrode, the peel strength and shapeability when made into an electrode fell and, further, the internal resistance and high temperature cycle characteristics when made into a cell fell (Comparative Examples 1-6 and 1-7).

Further, when dissolving the particle-shaped binder in N-methylpyrrolidone and a state not having a particle shape results and when using the binder in a state not having a particle shape, the internal resistance and high temperature cycle characteristics when made into a cell fell (Comparative Example 1-8).

Note that, among the above comparative examples, in Comparative Example 1-7, by coating an aqueous dispersion slurry which contains a positive electrode active material constituted by LiNiO₂ directly on the current collector constituted by aluminum foil, the aluminum foil corroded. Further, in Comparative Examples 1-7 and 1-8, since coating method was used to form the positive electrodes and negative electrodes, the trouble was observed of the binder segregating at the surface of the electrode active material layer.

### Example 2-1

### Production of Slurry for Composite Particle for Positive Electrode

A positive electrode active material constituted by LiNiO₂, 100 parts, an conductive material constituted by acetylene black (HS-100, made by Denki Kagaku Kogyo) 2 parts, a binder constituted by an aqueous dispersion of the particle-shaped saturated nitrile polymer (A2) which was obtained in Production Example 2, 1.25 parts converted to solid content, similarly a binder constituted by an aqueous dispersion of the particle-shaped acrylic polymer (B1) which was obtained in Production Example 20, 1.25 parts converted to solid content, an antioxidant (C1) which was obtained in Production Example 24, 0.025 part (1 part with respect to 100 parts of binder), and a dispersant constituted by a carboxymethylcellulose aqueous solution with a degree of etherification of 0.8, 2 parts converted to solid content were mixed, ion exchanged water was added in a suitable quantity, and the result was mixed and dispersed by a planetary mixer to prepare a slurry for composite particle for positive electrode with a solid content concentration of 20%.

Production of Composite Particles for Positive Electrode

The above obtained slurry for composite particle for positive electrode was spray dried for granulation using a spray drier (Ohkawara Kakohki) and using a rotary disk type atomizer (diameter 65 mm) under conditions of a speed of 25,000 rpm, a hot air temperature of 150° C., and a temperature at the particle recovery outlet of 90° C. to obtain composite particles for positive electrode. The obtained composite particles had an average volume particle size of 40 μm.

Production of Positive Electrode

The above obtained composite particles for positive electrode were supplied on a roll of a roll press (rough surface hot roll, made by Hirano Gikenkogyo) (roll temperature 100° C., press linear pressure 4.0 kN/cm) together with a current collector constituted by aluminum foil and were formed into a sheet shape by a shaping speed of 20 m/min on a current collector constituted by aluminum foil to obtain a positive electrode which has a thickness 80 μm positive electrode active material layer.

Production of Slurry for Composite Particle for Negative Electrode

A negative electrode active material constituted by artificial graphite (average particle size: 24.5 μm) 100 parts, a binder constituted by an aqueous dispersion of styrene-butadiene rubber (product name “BM-480B”, made by Zeon Corporation) 2.7 parts converted to solid content, and a dispersant constituted by a carboxymethylcellulose aqueous solution with a degree of etherification of 0.8, 0.7 part converted to solid content were mixed, ion exchanged water was added in a suitable quantity, and the result was mixed and dispersed by a planetary mixer to prepare a slurry for composite particle for negative electrode with a solid content concentration of 20%.

Production of Composite Particles for Negative Electrode

The above obtained slurry for composite particle for negative electrode was spray dried for granulation using a spray drier (Ohkawara Kakohki) and using a rotary disk type atomizer (diameter 65 mm) under conditions of a speed of 25,000 rpm, a hot air temperature of 150° C., and a temperature at the particle recovery outlet of 90° C. to obtain composite particles for negative electrode. The obtained composite particles had an average volume particle size of 40 μm.

Production of Negative Electrode

The above obtained composite particles for negative electrode were supplied on a roll of a roll press (rough surface hot roll, made by Hirano Gikenkogyo) (roll temperature 100° C., press linear pressure 4.0 kN/cm) together with a current collector constituted by copper foil and were formed into a sheet shape by a shaping speed of 20 m/min on a current collector constituted by copper foil to obtain a negative electrode which has a thickness 80 μm negative electrode active material layer.

Production of Lithium Ion Secondary Cell

The above obtained positive electrode was punched out to a diameter 13 mm disk shape and, further, the above obtained negative electrode was punched out to a diameter 14 mm disk shape. Further, on the 13 mm disk-shaped positive electrode, a diameter 18 mm, thickness 25 μm disk-shaped separator comprised of a polypropylene porous film and the 14 mm disk-shaped negative electrode were laminated in that order. This assembly was placed in a stainless steel coin-shaped outside container (diameter 20 mm, height 1.8 mm, stainless steel thickness 0.25 mm) in which a polypropylene packing was set. Next, this container was filled with an electrolytic solution (solvent: ethylene carbonate/diethyl carbonate=1/2 (volume ratio at 20° C.), electrolyte: 1M LiPF₆) so as not to leave any air, a thickness 0.2 mm stainless steel cap was placed and fastened on the outer container via the polypropylene packing, and the cell can was sealed to produce a diameter 20 mm, thickness about 2 mm coin-type lithium ion secondary cell (coin cell CR2032).

Further, the above obtained positive electrode was used to evaluate the peel strength and shapeability and the lithium ion secondary cell was used to evaluate the internal resistance, high temperature cycle characteristics, low temperature cycle characteristics, and low temperature output characteristics by the above-mentioned methods. Further, the iodine value of the particle-shaped binder which was used when producing the composite particles for positive electrode by the above was also measured in accordance with the above-mentioned method. The results are shown in Table 3.

### Examples 2-2 and 2-3

Except for using as the positive electrode active material which is used at the time of production of the composite particles for positive electrode, instead of LiNiO₂, LiFePO₄ (Example 2-2) and LiCoO₂ (Example 2-3), the same procedure was followed as in Example 2-1 to produce positive electrodes, negative electrodes, and lithium ion secondary cells and similarly evaluate them. The results are shown in Table 3.

### Examples 2-4 to 2-8

Except for using as the binder at the time of production of the composite particles for positive electrode, instead of the aqueous dispersion of the particle-shaped saturated nitrile polymer (A2) which was obtained in Production Example 2, the aqueous dispersions of the particle-shaped saturated nitrile polymers (A15) to (A19) which were obtained in Production Examples 15 to 19, the same procedure was followed as in Example 2-1 to produce positive electrodes, negative electrodes, and lithium ion secondary cells and similarly evaluate them. The results are shown in Table 3.

### Examples 2-9 to 2-11

Except for using as the binder at the time of production of the composite particles for positive electrode, instead of the aqueous dispersion of the particle-shaped acrylic polymer (B1) which was obtained in Production Example 20, the aqueous dispersions of the particle-shaped acrylic polymers (B2) to (B4) which were obtained in Production Examples 21 to 23, the same procedure was followed as in Example 2-1 to produce positive electrodes, negative electrodes, and lithium ion secondary cells and similarly evaluate them. The results are shown in Table 3.

### Example 2-12

Except for changing the amount of the aqueous dispersion of the binder constituted by the particle-shaped saturated nitrile polymer (A2) from 1.25 parts to 1.75 parts (converted to solid content) and similarly changing the amount of the aqueous dispersion of the binder constituted by the particle-shaped acrylic polymer (B1) from 1.25 parts to 0.75 part (converted to solid content) at the time of production of the composite particles for positive electrode, the same procedure was followed as in Example 2-1 to produce a positive electrode, negative electrode, and lithium ion secondary cell and similarly evaluate them. The results are shown in Table 3.

### Example 2-13

Except for changing the amount of the aqueous dispersion of the binder constituted by the particle-shaped saturated nitrile polymer (A2) from 1.25 parts to 0.75 part (converted to solid content) and similarly changing the amount of the aqueous dispersion of the binder constituted by the particle-shaped acrylic polymer (B1) from 1.25 parts to 1.75 parts (converted to solid content) at the time of production of the composite particles for positive electrode, the same procedure was followed as in Example 2-1 to produce a positive electrode, negative electrode, and lithium ion secondary cell and similarly evaluate them. The results are shown in Table 4.

### Examples 2-14 and 2-15

Except for changing the amount of the antioxidant (C1) at the time of production of the composite particles for positive electrode to 0.005 part (0.2 part with respect to 100 parts of binder) (Example 2-14) and 0.05 part (2 parts with respect to 100 parts of binder) (Example 2-15), the same procedure was followed as in Example 2-1 to produce a positive electrodes, negative electrodes, and lithium ion secondary cells and similarly evaluate them. The results are shown in Table 4.

### Examples 2-16 and 2-17

Except for using as the antioxidant which is used at the time of production of the composite particles for positive electrode, instead of the antioxidant (C1) which was obtained in Production Example 24, the antioxidant (C2) which was obtained in Production Example 25 (Example 2-16), bis(4-t-butylphenyl)amine (Example 2-17), the same procedure was followed as in Example 2-1 to produce positive electrodes, negative electrodes, and lithium ion secondary cells and similarly evaluate them. The results are shown in Table 4.

TABLE 3

| Examples | | | | | | | | | | | |
|---|---|---|---|---|---|---|---|---|---|---|---|
| 2-1 | 2-2 | 2-3 | 2-4 | 2-5 | 2-6 | 2-7 | 2-8 | 2-9 | 2-10 | 2-11 | 2-12 |

Composition of composite particles for positive electrode

| | | | | | | | | | | | | |
|---|---|---|---|---|---|---|---|---|---|---|---|---|
| LiNiO₂ (part) | 100 | — | — | 100 | 100 | 100 | 100 | 100 | 100 | 100 | 100 | 100 |
| LiFePO₄ (part) | — | 100 | — | — | — | — | — | — | — | — | — | — |
| LiCoO₂ (part) | — | — | 100 | — | — | — | — | — | — | — | — | — |
| Nitrile polymer (part) | 1.25 | 1.25 | 1.25 | 1.25 | 1.25 | 1.25 | 1.25 | 1.25 | 1.25 | 1.25 | 1.25 | 1.75 |
| Acrylic polymer (part) | 1.25 | 1.25 | 1.25 | 1.25 | 1.25 | 1.25 | 1.25 | 1.25 | 1.25 | 1.25 | 1.25 | 0.75 |
| Antioxidant (O1) (part) | 0.025 | 0.025 | 0.025 | 0.025 | 0.025 | 0.025 | 0.025 | 0.025 | 0.025 | 0.025 | 0.025 | 0.025 |
| Antioxidant (O2) (part) | — | — | — | — | — | — | — | — | — | — | — | — |
| bis(4-t-butylphenyl)amine (part) | — | — | — | — | — | — | — | — | — | — | — | — |

Nitrile polymer

| Type of nitrile polymer | | A2 | A2 | A2 | A15 | A16 | A17 | A18 | A19 | A2 | A2 | A2 | A2 |
|---|---|---|---|---|---|---|---|---|---|---|---|---|---|
| Form of nitrile polymer | | Particles | Particles | Particles | Particles | Particles | Particles | Particles | Particles | Particles | Particles | Particles | Particles |
| Composition | Acrylonitrile units (%) | 25 | 25 | 25 | 20 | 30 | 26 | 25 | 25 | 25 | 25 | 25 | 25 |
| | Butadiene units and saturated butadiene units (%) | 70 | 70 | 70 | 75 | 85 | 70 | 70 | 70 | 70 | 70 | 70 | 70 |
| | Methacrylic acid units (%) | 5 | 5 | 5 | 5 | 5 | 5 | 5 | — | 5 | 5 | 5 | 5 |
| | AMPS units (%) | — | — | — | — | — | — | — | 5 | — | — | — | — |

| | | | | | | | | | | | | |
|---|---|---|---|---|---|---|---|---|---|---|---|---|
| Iodine value (mg/100 mg) | 7 | 7 | 7 | 7 | 7 | 4 | 9 | 7 | 7 | 7 | 7 | 7 |

Acrylic polymer

| Type of acrylic polymer | | B1 | B1 | B1 | B1 | B1 | B1 | B1 | B1 | B2 | B3 | B4 | B1 |
|---|---|---|---|---|---|---|---|---|---|---|---|---|---|
| Form of acrylic polymer | | Particles | Particles | Particles | Particles | Particles | Particles | Particles | Particles | Particles | Particles | Particles | Particles |
| Composition | Acrylonitrile units (%) | 15 | 15 | 15 | 15 | 15 | 15 | 15 | 15 | 20 | — | 15 | 15 |
| | 2-ethylhexyl acrylate units (%) | 83 | 83 | 83 | 83 | 83 | 83 | 83 | 83 | 78 | 90 | 85 | 83 |
| | Methacrylic acid units (%) | 2 | 2 | 2 | 2 | 2 | 2 | 2 | 2 | 2 | 2 | — | 2 |

| | | | | | | | | | | | | |
|---|---|---|---|---|---|---|---|---|---|---|---|---|
| Iodine value of binder as a whole (mg/100 mg) | 5 | 5 | 5 | 5 | 5 | 3 | 7 | 5 | 5 | 5 | 5 | 6 |
| Amount of acrylonitrile units of binder as a whole (%) | 20 | 20 | 20 | 18 | 23 | 20 | 20 | 20 | 23 | 13 | 20 | 22 |

Evaluation

| | | | | | | | | | | | | |
|---|---|---|---|---|---|---|---|---|---|---|---|---|
| Peel strength of positive electrode | A | A | A | B | A | A | A | C | A | C | C | A |
| Shapeability | A | B | A | A | A | B | A | A | B | B | C | B |
| Internal resistance | A | A | A | A | B | A | A | B | B | C | B | B |
| High temperature cycle | A | A | B | B | B | A | B | B | B | C | C | B |
| characteristics | | | | | | | | | | | | |
| Low temperature cycle | A | A | A | B | A | A | B | B | B | C | C | C |
| characteristics | | | | | | | | | | | | |
| Low temperature output | A | A | A | B | A | A | B | B | B | C | C | C |
| characteristics | | | | | | | | | | | | |

TABLE 4

| | | | Examples | | | | |
|---|---|---|---|---|---|---|---|
| | | | 2-13 | 2-14 | 2-15 | 2-16 | 2-17 |
| Composition of composite particles | | | | | | | |
| for positive electrode | | | | | | | |
| LiNiO₂ | | (part) | 100 | 100 | 100 | 100 | 100 |
| LiFePO₄ | | (part) | — | — | — | — | — |
| LiCoO₂ | | (part) | — | — | — | — | — |
| Nitrile polymer | | (part) | 0.75 | 1.25 | 1.25 | 0.75 | 0.75 |
| Acrylic polymer | | (part) | 1.75 | 1.25 | 1.25 | 1.75 | 1.75 |
| Antioxidant (C1) | | (part) | 0.025 | 0.005 | 0.05 | — | — |
| Antioxidant (C2) | | (part) | — | — | — | 0.025 | — |
| bis(4-t-butylphenyl)amine | | (part) | — | — | — | — | 0.025 |
| Nitrile polymer | | | | | | | |
| Type of nitrile polymer | | | A2 | A2 | A2 | A2 | A2 |
| Form of nitrile polymer | | | Particles | Particles | Particles | Particles | Particles |
| Composition | Acrylonitrile units | (%) | 25 | 25 | 25 | 25 | 25 |
| | Butadiene units and | (%) | 70 | 70 | 70 | 70 | 70 |
| | saturated butadiene un [symbol] | | | | | | |
| | Methacrylic acid units | (%) | 5 | 5 | 5 | 5 | 5 |
| | AMPS units | (%) | — | — | — | — | — |
| Iodine value | | (mg/100 mg) | 7 | 7 | 7 | 7 | 7 |
| Acrylic polymer | | | | | | | |
| Type of acrylic polymer | | | B1 | B1 | B1 | B1 | B1 |
| Form of acrylic polymer | | | Particles | Particles | Particles | Particles | Particles |
| Composition | Acrylonitrile units | (%) | 15 | 15 | 15 | 15 | 15 |
| | 2-ethyhexyl acrylate units | (%) | 83 | 83 | 83 | 83 | 83 |
| | Methacrylic acid units | (%) | 2 | 2 | 2 | 2 | 2 |

| | | | | | | |
|---|---|---|---|---|---|---|
| Iodine value of binder as a whole | (mg/100 mg) | 4 | 5 | 5 | 4 | 4 |
| Amount of acrylonitrile units of | (%) | 18 | 20 | 20 | 18 | 18 |
| binder as a whole | | | | | | |
| Evaluation | | | | | | |
| Peel strength of positive electrode | | B | A | B | A | A |
| Shapeability | | C | A | A | A | B |
| Internal resistance | | B | C | C | B | B |
| High temperature cycle characteristics | | B | C | C | B | C |
| Low temperature cycle characteristics | | C | C | C | B | C |
| Low temperature output characteristics | | C | C | C | B | C |

[symbol]

indicates data missing or illegible when filed

### Evaluation of Examples 2-1 to 2-17

As shown in Tables 3 and 4, when using composite particles for positive electrode obtained by jointly using, as binder, particle-shaped nitrile polymer and particle-shaped acrylic polymer and containing an antioxidant, the obtained positive electrodes are excellent in peel strength and shapeability and, further, when made into cells, give ones which are low in internal resistance and excellent in high temperature cycle characteristics, low temperature cycle characteristics, and low temperature output characteristics (Examples 2-1 to 2-17).

1. Composite particles for electrochemical device electrode containing an electrode active material and a particle-shaped binder, wherein
said binder includes a copolymer which contains a nitrile group-containing monomer unit, a monomer unit which has an acidic functional group, and a monomer unit which contains a C₄ or more linear alkylene structure, in which a ratio of content of said nitrile group-containing monomer unit is 10 to 50 wt % and the iodine value is 3 to 40 mg/100 mg.

2. The composite particles for electrochemical device electrode as set forth in claim 1, wherein said acidic functional group is at least one group which is selected from a carboxylic acid group, sulfonic acid group, and phosphoric acid group.

3. The composite particles for electrochemical device electrode as set forth in claim 1, wherein
said binder includes an acrylic polymer which contains a (meth)acrylic acid ester monomer unit as a main ingredient, and
an iodine value of the binder as a whole is 3 to 30 mg/100 mg.

4. The composite particles for electrochemical device electrode as set forth in claim 3 further containing an antioxidant in 0.05 to 3 parts by weight with respect to 100 parts by weight of said binder.

5. The composite particles for electrochemical device electrode as set forth in claim 4, wherein said antioxidant is an amine-based antioxidant and/or phenol-based antioxidant.

6. A material for electrochemical device electrode including the composite particles for electrochemical device electrode as set forth in claim 1.

7. An electrochemical device electrode comprising an active material layer which is formed by using the material for electrochemical device electrode as set forth in claim 6 laminated on a current collector.

8. The electrochemical device electrode as set forth in claim 7, wherein said electrode active material layer is laminated on said current collector by press forming.

9. The electrochemical device electrode as set forth in claim 7, wherein said electrode active material layer is laminated on said current collector by roll press forming.

10. An electrochemical device which is provided with an electrochemical device electrode as set forth in claim 7.

11. A method of production of the composite particles for electrochemical device electrode as set forth in claim 1,
comprising a step of making said electrode active material and said binder disperse in water to obtain a slurry and a step of spraying and drying said slurry to form granules.

12. A method of production of the composite particles for electrochemical device electrode as set forth in claim 4,
comprising a step of making said electrode active material, said binder, and said antioxidant disperse in water to obtain a slurry and a step of spraying and drying said slurry to form granules.
